(19) United States
(12) Patent Application Publication
(10) Pub. No.: US 2015/0331600 A1
(43) Pub. Date: Nov. 19, 2015

(54) OPERATING METHOD USING AN INPUT CONTROL OBJECT AND ELECTRONIC DEVICE SUPPORTING THE SAME

(71) Applicant: Samsung Electronics Co., Ltd., Gyeonggi-do (KR)

(72) Inventors: Hong Chan PARK, Gyeonggi-do (KR); Wan Gyu Kim, Gyeonggi-do (KR)

(73) Assignee: Samsung Electronics Co., Ltd.

(21) Appl. No.: 14/713,817

(22) Filed: May 15, 2015

(30) Foreign Application Priority Data
May 15, 2014 (KR) 10-2014-0058334

(51) Int. Cl. G06F 3/0484; G06F 3/0481; G06F 3/0488; G06F 3/0482

(52) U.S. Cl. CPC G06F 3/04847; G06F 3/0482; G06F 3/04817; G06F 3/04842; G06F 3/0488

(57) ABSTRACT

Methods and apparatuses are provided for operating an input control object. At least one virtual input control object is output to a display in response to a first event. The at least one virtual input control object is moved on the display in a designated direction or at a designated speed according to a second event. A function related to the at least one virtual input control object is performed according to a third event.

### PRIORITY

This application claims priority under 35 U.S.C. §119(a) to Korean Patent Application No. 10-2014-058334 filed May 15, 2014, the content of which is incorporated herein by reference.

### BACKGROUND

1. Field of the Disclosure

The present disclosure relates generally to an input operation of an electronic device, and more particularly, to an input operation using an input control object and an electronic device supporting the same.

2. Description of the Related Art

Various electronic devices exist that support mobile communications and personal information processing, such as, for example, mobile communication terminals, personal digital assistants (PDAs), electronic organizers, smartphones and tablet personal computers (PCs). Such electronic devices have advanced to provide not only their own conventional functions but also functions of other devices, resulting in mobile convergence.

Display areas of such electronic devices have been increased to display more information and satisfy users' needs.

As the display areas of electronic devices are increased, it becomes more difficult for users to perform a touch operation on an electronic device while also gripping the electronic device.

### SUMMARY

The present disclosure has been made to address at least the above problems and/or disadvantages and to provide at least the advantages described below. Accordingly, an aspect of the present disclosure provides an input control object operating method for facilitating an input control operation related to a screen change of a display module, and an electronic device supporting the same.

According to an aspect of the present disclosure, a method is provided for operating an input control object. At least one virtual input control object is output to a display in response to a first event. The at least one virtual input control object is moved on the display in a designated direction or at a designated speed according to a second event. A function related to the at least one virtual input control object is performed according to a third event.

According to another aspect of the present disclosure, an electronic device is provided that includes a display configured to output at least one virtual input control object in response to a first event. The electronic device also includes an object processing module configured to move the at least one virtual input control object in a designated direction or at a designated speed according to a second event, and perform a function related to the at least one virtual input control object according to a third event.

### BRIEF DESCRIPTION OF THE DRAWINGS

The above and other aspects, features and advantages of the present disclosure will be more apparent from the following detailed description, taken in conjunction with the accompanying drawings, in which:

FIG. 1 is a diagram illustrating an environment of an electronic device related to input control, according to an embodiment of the present disclosure;

FIG. 2 is a diagram illustrating an object processing module, according to an embodiment of the present disclosure;

FIG. 3 is a flowchart illustrating an input control object operating method, according to an embodiment of the present disclosure;

FIG. 4 is a flowchart illustrating an input control object setting method, according to an embodiment of the present disclosure;

FIG. 5 is a diagram illustrating generation of an input control object, according to an embodiment of the present disclosure;

FIG. 6 is a diagram illustrating generation of the input control object, according to another embodiment of the present disclosure;

FIG. 7 is a diagram illustrating movement of the input control object based on a touch event, according to an embodiment of the present disclosure;

FIG. 8 is a diagram illustrating movement of the input control object based on a touch event, according to another embodiment of the present disclosure;

FIG. 9 is a diagram illustrating operation of the input control object based on a sensor event, according to an embodiment of the present disclosure;

FIG. 10 is a diagram illustrating operation of a plurality of input control objects, according to an embodiment of the present disclosure;

FIG. 11A is a diagram illustrating movement of the input control object associated with a display item, according to an embodiment of the present disclosure;

FIG. 11B is a diagram illustrating movement control of the input control object, according to an embodiment of the present disclosure;

FIG. 12 is a diagram illustrating movement of the input control object associated with a display item, according to another embodiment of the present disclosure;

FIG. 13 is a diagram illustrating modification of the input control object associated with a display item, according to an embodiment of the present disclosure;

FIG. 14 is a diagram illustrating output of the input control object based on a grip direction, according to an embodiment of the present disclosure;

FIG. 15 is a diagram illustrating an execution function based on operation of the input control object, according to an embodiment of the present disclosure;

FIG. 16 is a diagram illustrating the operation of the input control object associated with execution of a function, according to an embodiment of the present disclosure;

FIG. 17 is a diagram illustrating map movement of the input control object according to an embodiment of the present disclosure;

FIG. 18 is a diagram illustrating attribute control of the input control object, according to an embodiment of the present disclosure; and

FIG. 19 is a block diagram illustrating an electronic device, according to an embodiment of the present disclosure.

### DETAILED DESCRIPTION OF EMBODIMENTS OF THE PRESENT DISCLOSURE

Embodiments of the present disclosure are described with reference to the accompanying drawings. The same or similar components may be designated by the same or similar reference numerals although they are illustrated in different drawings. Detailed descriptions of constructions or processes known in the art may be omitted to avoid obscuring the subject matter of the present disclosure.

The terms “include,” “comprise,” “including,” or “comprising”, as used herein, indicate disclosed functions, operations, or existence of elements, but do not exclude other functions, operations or elements. The terms “include”, “including”, “comprise”, “comprising”, “have”, or “having”, as used herein, specify the presence of stated features, numbers, operations, elements, components, or combinations thereof, but do not preclude the presence or addition of one or more other features, numbers, operations, elements, components, or combinations thereof.

The meaning of the term “or” “at least one of A and/or B”, as used herein, includes any and all combinations of words listed together with the term. For example, the expression “A or B” or “at least one of A and/or B” may indicate A, B, or both A and B.

Terms such as “first”, “second”, and the like, as used herein, may refer to various elements of various embodiments of the present disclosure, but do not limit the elements. For example, such terms do not limit the order and/or priority of the elements. Furthermore, such terms may be used to distinguish one element from another element. For example, a first user device and a second user device indicate different user devices. Further, without departing the scope of the present disclosure, a first element may be referred to as a second element, and similarly, a second element may be referred to as a first element.

It will be understood that when an element is referred to as being “connected” or “coupled” to another element, it can be directly connected or coupled to the other element or intervening elements may be present. In contrast, when an element is referred to as being “directly connected” or “directly coupled” to another element, it should be understood that there are no intervening elements.

The terminology used herein is not used to limit the present disclosure, and is instead used for describing specific various embodiments of the present disclosure. The terms using a singular form may include plural forms unless otherwise specified.

The terms used herein, including technical or scientific terms, have the same meanings as those understood by those skilled in the art unless otherwise defined herein. Commonly used terms, such as those defined in a dictionary, should be interpreted in the same context as in the related art and should not be interpreted in an idealized or overly formal sense unless otherwise explicitly defined.

Electronic devices, according to an embodiment of the present disclosure, may support an object output function related to input control. For example, the electronic device may be embodied as at least one of a smartphone, a tablet PC, a mobile phone, a video phone, an electronic book reader, a desktop PC, a laptop PC, a netbook computer, a PDA, a portable multimedia player (PMP), an MP3 player, a mobile medical device, a camera, and a wearable device (e.g., a head-mounted-device (HMD) such as, for example, electronic glasses, electronic apparel, an electronic bracelet, an electronic necklace, an electronic appcessory, an electronic tattoo, or a smart watch).

According to an embodiment of the present disclosure, the electronic device may be embodied as a smart borne appliance having an object output function related to input control, The smart home appliance may include at least one of, for example, a TV, a DVD player, an audio player, a refrigerator, an air conditioner, a cleaner, an oven, a microwave oven, a washing machine, an air cleaner, a set-top box, a TV box, a game console, an electronic dictionary, electronic keys, a camcorder, or an electronic picture frame.

According to an embodiment of the present disclosure, the electronic device may include at least one of a medical device (e.g., magnetic resonance angiography (MRA), magnetic resonance imaging (MRI), computed tomography (CT), a scanner, and an ultrasonic device), a navigation device, a global positioning system (GPS) receiver, an event data recorder (IDR), a flight data recorder (FRD), a vehicle infotainment device, electronic equipment for ships (e.g., navigation systems and gyrocompasses), avionics, a security device, a head unit for vehicles, an industrial or home robot, an automatic teller machine (ATM), and a points of sale (POS).

According to an embodiment of the present disclosure, the electronic device may include at least one of a part of furniture or buildings/structures, an electronic board, an electronic signature receiving device, a projector, or a measuring instrument (e.g., a water meter, an electricity meter, a gas meter, or a wave meter) having an object output function related to input control. The electronic device, according to an embodiment of the present disclosure may be one or more combinations of the above-described devices. Furthermore, the electronic device, according to an embodiment of the present disclosure may be a flexible device. It would be obvious to those skilled in the art that the electronic device, according to an embodiment of the present disclosure, is not limited to the above-described devices.

Hereinafter, an electronic device, according to an embodiment of the present disclosure, is described with reference to the accompanying drawings. The term “user”, as used herein, may refer to a person who uses an electronic device or may refer to a device (e.g., an artificial electronic device) that uses the electronic device.

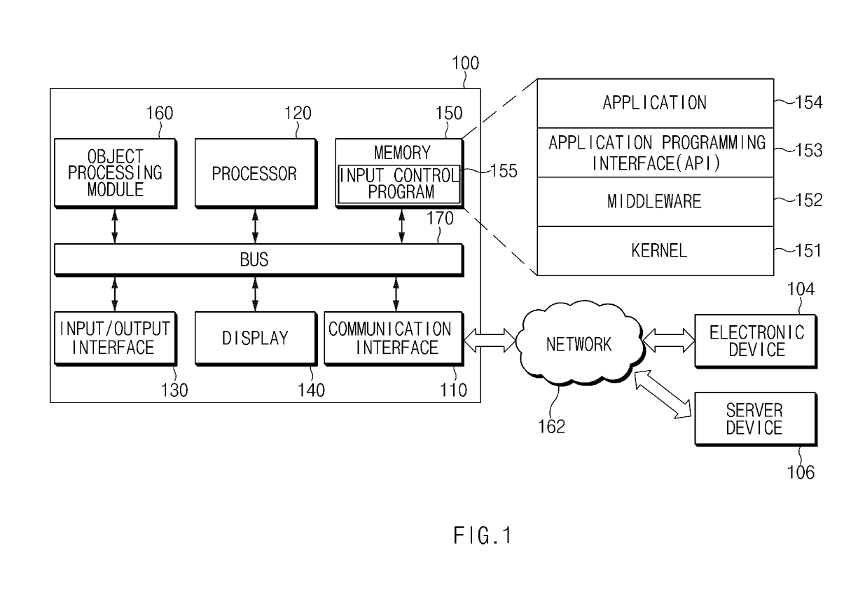

FIG. 1 is a diagram illustrating an environment of an electronic device related to input control, according to an embodiment of the present disclosure.

Referring to FIG. 1, the environment includes an electronic device 100, a network 162, a server device 106, and an external electronic device 104.

According to an embodiment of the present disclosure, the electronic device 100 includes a communication interface 110, a processor 120, an input/output interface 130, a display 140, a memory 150, an object processing module 160, and a bus 170.

The bus 170 may be a circuit for connecting the foregoing elements to one another and for allowing communication (e.g., control message transfer) between the foregoing elements.

The processor 120 may receive instructions from other elements (e.g., the memory 150, the communication interface 110, the display 140, the input/output interface 130, or the object processing module 160) through the bus 170. The processor 120 may interpret the received instructions, and may perform operations or process data according to the interpreted instructions. According to an embodiment of the present disclosure, the electronic device 100 may output at least one virtual input control object (hereinafter referred to as an input control object) to the display 140 in response to an event occurrence. The electronic device 100 may control movement of the input control object in response to an input event such as, for example, a motion event (e.g., a designated gesture (motion) event or a sensor event related to an acceleration change or a state change due to movement of the electronic device 100) or a touch event. The electronic device 100 may select at least one item (e.g., an object (an icon, an image, or text related to execution of a specific application, or an icon, an image, or text related to execution of a specific file or data) displayed on the display (140)), or may generate an input event related to a screen change using the input control object. Accordingly, the electronic device 100 may easily control a screen change and item selection of the display 140 regardless of various conditions related to device operation, such as, for example, a grip state or a position state of an electronic device.

According to an embodiment of the present disclosure, the communication interface 110 may include at least one communication unit related to a communication function of the electronic device 100. For example, the communication interface 110 may include at least one of various communication units including a mobile communication unit, a broadcast receiving unit, such as a digital multimedia broadcasting (DMB) module or a digital video broadcasting-handheld (DVB-H) module, a short-range communication unit, such as a Bluetooth module, a ZigBee module, or an NEC module, a Wi-Fi communication unit, and a location information collection unit. According to an embodiment of the present disclosure, the communication interface 110 may receive at least one input control object from another electronic device or a server device. Furthermore, the communication interface 110 may transmit an input control object created according to a user input or a stored input control object to the external electronic device 104 or the server device 106.

According to an embodiment of the present disclosure, the communication interface 110 may be activated in response to an input event generated by the input control object. For example, the communication interface 110 may establish a traffic channel to the external electronic device 104 in response to a gesture motion or an item selection motion of the input control object on the display 140. Alternatively, the communication interface 110 may establish a communication channel to the server device 106 in response to the gesture motion or the item selection motion of the input control object. For example, the communication interface 110 may enable communication between the electronic device 100 and the external electronic device 104 or the server device 106. For example, the communication interface 110 may be connected to the network 162 through wireless or wired communication so as to communicate with the external electronic device 104 or the server device 106. The wireless communication may include at least one of WiFi communication, Bluetooth (BT) communication, near field communication (NFC), global positioning system (GPS) or cellular communication (e.g., long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM)). The wired communication may include at least one of universal serial bus (USB) communication, high definition multimedia interface (HDMI) communication, recommended standard 232 (RS-232) communication, or plain old telephone service (POTS) communication.

According to an embodiment of the present disclosure, the network 162 may be a telecommunications network. The telecommunications network may include at least one of a computer network, the Internet, the Internet of things, or a telephone network. According to an embodiment of the present disclosure, a protocol (e.g., a transport layer protocol, a data link layer protocol or a physical layer protocol) for communication between the electronic device 100 and the external device may be supported by at least one of an application 154, an application programming interface 153, a middleware 152, a kernel 151, or the communication interface 110.

According to an embodiment of the present disclosure, the server device 106 may support operation of the electronic device 100 by performing at least one operation (or function) implemented in the electronic device 100.

The input/output interface 130 may transfer an instruction or data input by a user through an input/output device (e.g., a sensor, a keyboard, or a touch screen) to the processor 120, the memory 150, the communication interface 110, or the object processing module 160 via the bus 170 for example. For example, the input/output interface 130 may provide, to the processor 120, data on a touch of the user input through a touch screen. Furthermore, the input/output interface 130 may output, through the input/output device (e.g., a speaker or a display), the instruction or data received from the bus 170, the processor 120, the memory 150, the communication interface 110, or the object processing module 160. For example, the input/output interface 130 may output voice data processed by the processor 120 to the user through a speaker. According to an embodiment of the present disclosure, the input/output interface 130 may generate an input signal of the electronic device 100. The input/output interface 130 may include, for example, at least one of a keypad, a dome switch, a touchpad (resistive/capacitive type), a jog wheel, or a jog switch. The input/output interface 130 may be implemented in the form of a button on the exterior of the electronic device 100. Some buttons may be implemented in the form of virtual key buttons. When the display 140 supports a touch function, the display 140 may be operated as an element of the input/output interface 130. The input/output interface 130 may include a plurality of keys for receiving number or text information and setting various functions. Such keys may include a menu call key, a screen on/off key, a power on/off key, a volume control key, and a home key.

According to an embodiment of the present disclosure, the input/output interface 130 may generate an input signal related to a call of at least one input control object or an input signal related to removal of at least one input control object according to control by the user. Furthermore, the input/output interface 130 may generate an input signal for controlling movement and item selection of the input control object. Moreover, the input/output interface 130 may generate an input signal for calling a plurality of input control objects at one time, or an input signal for removing a plurality of input control objects at one time according to the control by the user.

According to an embodiment of the present disclosure, the input/output interface 130 may generate an input signal for controlling an attribute of the input control object according to the control by the user. For example, the input/output interface 130 may generate an input signal for controlling at least one of a size, a speed, a shape, a duration of life of the input control object, strength, or a location thereof in a display module. The input/output interface 130 may generate an input signal for executing or deleting an item selected by the input control object, or changing an attribute of the item, or controlling a movement characteristic thereof. The input/output interface 130 may generate an input signal for setting the type of an input event generated according to a gesture motion of the input control object.

According to an embodiment of the present disclosure, the input/output interface 130 may process an audio signal of the electronic device 100. For example, the input/output interface 130 may transfer an audio signal received from the object processing module 160 to a speaker. The input/output interface 130 may transfer an audio signal, such as a voice received from a microphone, to the object processing module 160. The input/output interface 130 may convert the audio signal, such as the voice signal received from the microphone, into a digital signal to transfer the digital signal to the control module 160.

According to an embodiment of the present disclosure, the input/output interface 130 may output a guide sound or an effect sound related to at least one of output of the input control object, movement of the input control object, and removal of the input control object. The input/output interface 130 may output various guide sounds or effect sounds according to an overlap or a distance between the input control object and an item displayed on the display 140 while the input control object is moved on the display 140. Furthermore, the input/output interface 130 may output a relevant guide sound or effect sound if the input control object arrives at an edge area of the display 140 while being moved thereon. The output of the guide sound or effect sound of the input/output interface 130 may be disabled according to a user setting.

The display 140 may display various information (e.g., multimedia data or text data) to the user. According to an embodiment of the present disclosure, the display 140 may output various screens related to functions performed in the electronic device 100. For example, the display 140 may output a standby screen, a menu screen, a lock screen, or a specific function execution screen. According to an embodiment of the present disclosure, the display 140 may output a virtual input control object to a specific location or a predetermined location on the standby screen, the menu screen, the lock screen, or the specific function execution screen. The display 140 may change the output location (e.g., the specific location or the predetermined location) of the input control object on the basis of an event of an input module while performing a function of controlling a terminal using the virtual input control object.

The display 140 may include at least one of a liquid crystal display (LCD), a thin film transistor LCD (TFT LCD), a light emitting diode (LED), an organic LED (OLED), an active matrix OLED (AMOLED), a flexible display, a bended display, or a 3D display. Some of the displays may be transparent or light transmissive displays.

Furthermore, the display 140 may be provided as a touch-screen so that the display 140 may be used as not only an output unit but also an input unit. The display 140 may include a touch panel and a display panel. The touch panel may be placed on the display panel. The touch panel may be an add-on type touch panel positioned on the display panel or an on-cell type or in-cell type touch panel inserted into the display panel. The touch panel transfers, to the object processing module 160, a user input corresponding to a gesture of the user on the display 140. The user input generated by a touching means, such as a finger or a touch pen, may include a touch, a multi-touch, a tap, a double tap, a long tap, tap & touch, drag, flick, press, pinch in, or pinch out. The user input may be defined with respect to output, operation, or removal of the input control object. For example, an input event, such as a long press, pinch zoom in/out, or multi-touch, may be defined as an event for calling at least one input control object. An input event, such as drag, flick, tap, or double tap, may be defined as an event related to movement of at least one input control object. The input event, such as double tap, long tap, pinch zoom in/out, or multi-touch, may be defined as an event related to selection, deletion, execution, or movement of a specific item.

The memory 150 may store an instruction or data received from or generated by the processor 120 or another element (e.g., the communication interface 110, the display 140, the input/output interface 130, or the object processing module 160). The memory 150 may include programming modules such as the kernel 151, the middleware 152, the application programming interface (API) 153, or the application 154. Each programming module may include software, firmware, hardware, or a combination of at least two thereof.

The kernel 151 may control or manage system resources (e.g., the bus 170, the processor 120, or the memory 150) used to perform an operation or a function of another programming module, for example, the middleware 152, the API 153, or the application 154. Furthermore, the kernel 151 may provide an interface for allowing the middleware 152, the API 153, or the application 154 to access individual elements of the electronic device 100 in order to control or manage the elements.

The middleware 152 may serve as an intermediary between the API 153 or the application 154 and the kernel 151 so that the API 153 or the application 154 communicates and exchanges data with the kernel 151. Furthermore, the middleware 152 may perform a control operation (e.g., scheduling or load balancing) with respect to operation requests received from the application 154, using, e.g., a method of assigning a priority for using system resources (e.g., the bus 170, the processor 120, or the memory 150) of the electronic device 100 to at least one application 154.

The API 153, which is an interface for allowing the application 154 to control a function provided by the kernel 151 or the middleware 152, may include at least one interface or function (e.g., an instruction) for, for example, file control, window control, image processing, or character control.

According to an embodiment of the present disclosure, the application 154 may include an short message service (SMS)/multimedia messaging service (MMS) application, an electronic mail application, a calendar application, an alarm application, a health care application (e.g., an application for measuring an amount of exercise or blood sugar), or an environment information application (e.g., an application for providing atmospheric pressure, humidity or temperature information). Additionally or alternatively, the application 154 may be an application related to information exchange between the electronic device 100 and the external electronic device 104. The application related to information exchange may include, for example, a notification relay application for transferring specific information to the external electronic device or a device management application for managing the external electronic device.

For example, the notification relay application may include a function of transferring notification information generated by another application (e.g., an SMS/MMS application, an electronic mail application, a health care application or an environment information application) to the external electronic device 104. Additionally or alternatively, the notification relay application may receive notification information from the external electronic device 104 and may provide the notification information to the user. The device management application may manage (e.g., install, uninstall or update) a function (e.g., turning on/off the external electronic device (or a component thereof) or adjusting brightness (or resolution) of a display thereof) of at least a part of the external device 104 communicating with the electronic device 100, an application running in the external electronic device, or a service (e.g., a call service or a messaging service) provided from the external electronic device.

According to an embodiment of the present disclosure, the application 154 may include a designated application according to an attribute (e.g., the type) of external electronic device 104. For example, if the external electronic device 104 is an MP3 player, the application 154 may include an application related to playback of music. Similarly, if the external electronic device 104 is a mobile medical device, the application 154 may include an application related to health care. According to an embodiment of the present disclosure, the application 154 may include at least one of an application designated for the electronic device 100 or an application received from the server device 106 or the external electronic device 104.

The memory 150 may store various programs and data related to processing and control of data for operating the electronic device 100. For example, the memory 150 may store an operating system. According to an embodiment of the present disclosure, the memory 150 stores an input control program 155. The input control program 155 may include a routine (e.g., an instruction set or a syntax, function, template or class related thereto) related to generation of the input control object, a routine related to movement of the input control object, and a routine related to removal of the input control object. Furthermore, the input control program 155 may include a routine for supporting item selection, item deletion, item movement, or item-related function execution by the input control object. Moreover, the input control program 155 may include a routine for setting the input control object.

The object processing module 160 may process or transfer data or control signals related to the operation of the electronic device 100. According to an embodiment of the present disclosure, the object control module 160 may control processing or transfer of data related to operation of the input control object. Furthermore, the object processing module 160 may control processing, storage or application of data related to a setting of the input control object.

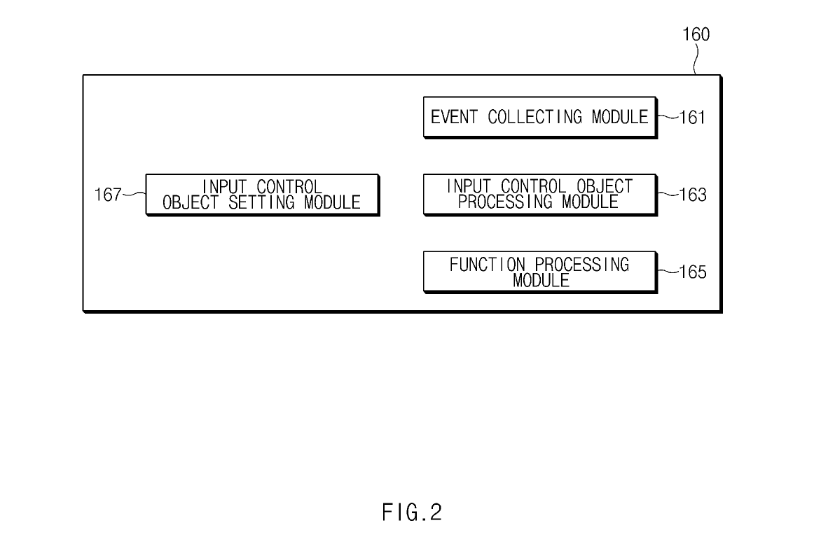

FIG. 2 is a diagram illustrating an object processing module, according to an embodiment of the present disclosure.

Referring to FIG. 2, an object processing module 160, according to an embodiment of the present disclosure, includes an event collecting module 161, an input control object processing module 163, a function processing module 165, and an input control object setting module 167.

The event collecting module 161 may collect an event that occurs in at least one of the display 140 or the input/output interface 130. For example, the event collecting module 161 may collect a touch-related event or a key-input-related event. According to an embodiment of the present disclosure, when the electronic device 100 includes a sensor module (e.g., an acceleration sensor or a geomagnetic sensor), the event collecting module 161 may collect a sensor event (e.g., a sensor event due to a shaking motion or a sensor event due to a tilting motion) according to operation of a sensor. The event collecting module 160 may transfer a collected event to the input control object processing module 163, the function processing module 165, or the input control object setting module 167.

According to an embodiment of the present disclosure, the input control object processing module 163 may output at least one input control object to the display 140 in response to an event transferred from the event collecting module 161. For example, the input control object processing module 163 may output at least one input control object to a specific location on the display 140 when an event that has occurred. The input control object processing module 163 may also output at least one input control object to a certain location on the display 140 according to a screen of a function being executed.

According to an embodiment of the present disclosure, the input control object processing module 163 may dispose the input control object on a specific layer of the display 140. The specific layer, which is a virtual layer for dividing overlapping screens on the display 140, may be an uppermost layer. For example, once an event related to an input control object call occurs while a standby (or idle) screen or a home screen is output, the input control object processing module 163 may dispose (or display) a virtual transparent layer as the uppermost layer on the display 140. The input control object may be disposed on a certain location on the virtual transparent layer. For example, the input control object may be disposed on the standby screen or the home screen. The virtual transparent layer may receive an input event such as a touch event. When the virtual transparent layer is disposed on the standby screen, the touch event that occurs on the virtual transparent layer may be applied in relation to operation of the input control object. When removal of the input control object is requested, the input control object may be removed concurrently with removal of the virtual transparent layer.

According to an embodiment of the present disclosure, the input control object processing module 163 may control output of a layer including a specific input area related to control of the input control object. For example, the input control object may be called while a sound source playback screen is displayed on the display 140. The input control object processing module 163 may provide an input area to at least one location (e.g., a corner or edge area or a center area) of the display 140 while outputting the input control object to the display 140. The input area may be provided to a certain area of the sound source playback screen in relation to control of the input control object. Alternatively, a layer including the input area may be disposed on the sound source playback screen. An input event that occurs on the input area, such as a touch event, may be applied to operate the input control object. An area other than the input area, such as a touch event that occurs on a control key area of the sound source playback screen, may be applied to control playback of a sound source.

According to an embodiment of the present disclosure, the input control object processing module 163 may move or display the input control object in response to an event transferred from the event collecting module 161. The input control object processing module 163 may adjust a moving speed of the input control object (e.g., may change the moving speed so that the moving speed differs from a previous moving speed) according to a relative location of the input control object with respect to an item displayed on the display 140 while moving and displaying the input control object. The input control object processing module 163 may adjust a size, color, or contrast of the input control object according to whether the input control object overlaps items or according to the locations of the input control object and the items. The input control object processing module 163 may change a moving path of the input control object according to the location of the input control object and the location of the item.

According to an embodiment of the present disclosure, the input control object processing module 163 may allow a specific item to be selected according to a selection attribute set for the input control object. The input control object processing module 163 may move an item, which overlaps at least a part of the input control object, to a specific location on the display 140 according to a movement attribute of the input control object. The input control object processing module 163 may request the function processing module 165 to delete an item that overlaps at least a part of the input control object according to a deletion attribute of the input control object. The input control object processing module 163 may request the function processing module 165 to perform a function of an item that overlaps at least a part of the input control object according to an execution attribute of the input control object.

According to an embodiment of the present disclosure, the function processing module 165 may perform a specific function based on an event transferred from the event collecting module 161, or based on an event transferred from the input control object processing module 163. For example, the function processing module 165 may delete an item designated by the input control object in response to a request from the input control object processing module 163. Alternatively, the function processing module 165 may control execution of a function related to an item designated by the input control object. According to an embodiment of the present disclosure, the function processing module 165 may control execution of a specific function in response to a specific gesture by the input control object. For example, when a specific motion of the input control object occurs, the function processing module 165 may execute a set specific function, and a screen is output based on the execution of the function.

According to an embodiment of the present disclosure, the input control object setting module 167 may support setting of the input control object. Specifically, the input control object setting module 167 may output an input control object setting screen to the display 140. The input control object setting module 167 may define an attribute of the input control object according to an event transferred from the event collecting module 161.

The electronic device 100 for supporting the operation of the input control object, according to an embodiment of the present disclosure, may perform various input control operations based on output, operation, editing, or removal of the input control object.

According to various embodiments of the present disclosure, an electronic device according to an embodiment of the present disclosure may include a display for outputting at least one input control object in response to an event that occurs in the electronic device, and an object processing module for moving the input control object in a direction or at a speed designated on the basis of a first event to display the input control object, or performing a function related to the input control object on the basis of an event following the first event or a second event independent from the first event.

According to various embodiments of the present disclosure, the object processing module may output the input control object to a designated location on the display.

According to various embodiments of the present disclosure, the object processing module may output the input control object to a certain location on the display related to an occurrence location of the event (related to output of the input control object).

According to various embodiments of the present disclosure, the object processing module may output at least one input control object in response to at least one of occurrence of a specified touch event, occurrence of a specified sensor event, occurrence or a specified virtual button selection event, occurrence of a specified hardware button selection event, occurrence of a specified touch event on a certain area of the display, execution of a specific function, or occurrence of a plurality of specified touch events.

According to various embodiments of the present disclosure, the object processing module may output a specific function execution screen to the display according to a designated motion of the input control object.

According to various embodiments of the present disclosure, the object processing module may control at least one of removal of a selected item, execution of a function supported by the selected item, or location movement of the selected item according to movement of the input control object.

According to various embodiments of the present disclosure, the object processing module may move the input control object in response to a touch event that occurs on an uppermost layer.

According to various embodiments of the present disclosure, the object processing module may change at least one of a moving speed, a size, a location, a shape or a duration of life of the input control object on the basis of a relative location of the input control object with respect to an item output to the display.

According to various embodiments of the present disclosure, the object processing module may change at least one of the moving speed or the size of the input control object on the basis of a distance between the input control object and the item output to the display or whether the input control object and the item output to the display overlap each other.

According to various embodiments of the present disclosure, the object processing module may move the input control object so that the input control object is adjacent to the item output to the display when the input control object approaches within a specific distance from the item.

According to various embodiments of the present disclosure, the object processing module may assign an input area for generating a touch event related to movement control of the input control object, and may output a map related to movement of the input control object.

According to various embodiments of the present disclosure, the object processing module may adjust at least one of a function application attribute, a movement-related attribute or a life time of the input control object.

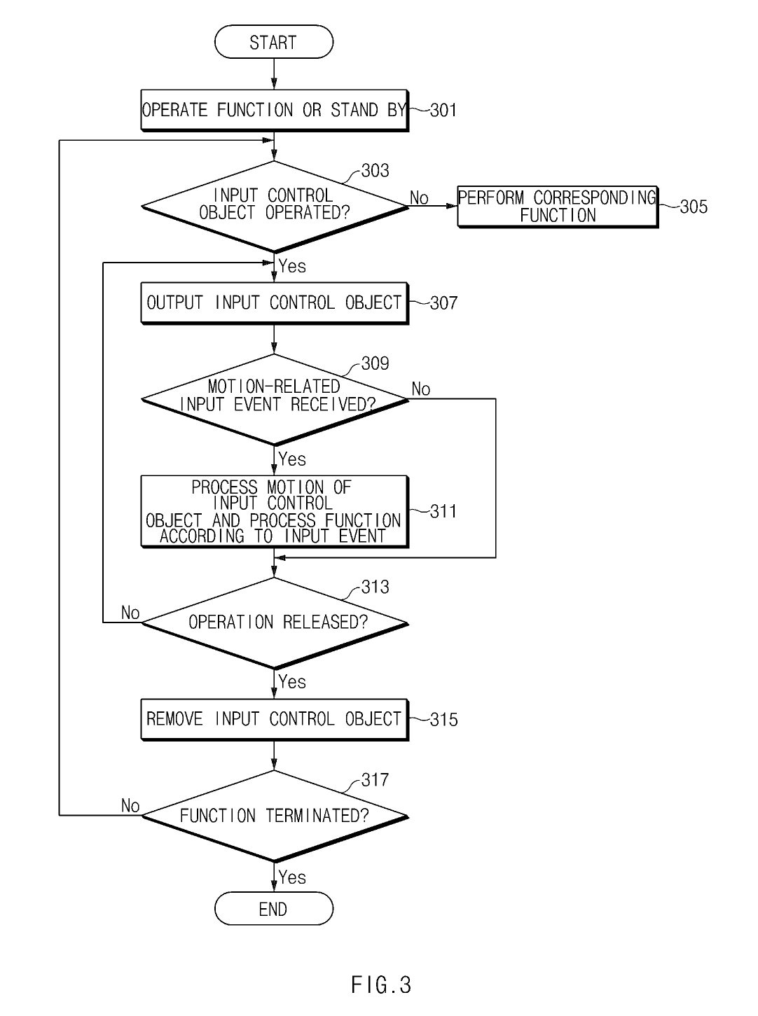

FIG. 3 is a flowchart illustrating an input control object operating method, according to an embodiment of the present disclosure.

Referring to FIG. 3, the object processing module 160 performs a functional operation or a standby operation, in operation 301. For example, the object processing module 160 may allow a specific application to be executed, may support a sleep mode (or function), or may maintain a lock screen state. Alternatively, the object processing module 160 may output a menu item or an icon related to a call of the input control object.

In operation 303, the object processing module 160 determines whether an event or a setting related to the operation of the input control object occurs. For example, the object processing module 160 may determine whether an event of selecting a menu item or an icon related to the operation of the input control object occurs. Alternatively, the object processing module 160 may determine whether a device state or predetermined function execution related to the operation of the input control object occurs. According to an embodiment of the present disclosure, at least one function or state, such as, for example, a standby screen state, gallery function execution, message function execution, a menu screen state, file management function execution, or Internet function execution, may have an input control object operation setting. Accordingly, operation 303 may be a process of determining whether the foregoing function execution or a state change occurs.

If there is an event or a setting related to the operation of the input control object does not occur in operation 303, the object processing module 160 controls execution of a specific function, in operation 305. For example, the object processing module 160 may control execution of a new application, or may allow a specific function of a running application to be performed according to the type or a characteristic of an event that has occurred. Alternatively, the object processing module 160 may release a sleep mode state or a lock screen state according to the type of the event. Alternatively, the object processing module 160 may maintain the sleep mode state or the lock screen state, or may maintain a previous function execution state.

If there an event or a setting related to the operation of the input control object occurs in operation 303, the object processing module 160 outputs the input control object, in operation 307. At least one input control object may be output. According to an embodiment of the present disclosure, one input control object or a plurality of input control objects may be output according to the type of an event, the type of an executed function, or a state type of the electronic device 100. According to an embodiment of the present disclosure, the input control object may be output to a certain location adjacent to a location where an event occurs, a certain location adjacent to a specific object displayed for a function being executed, or a predetermined specific location.

In operation 309, the object processing module 160 determines whether a motion-related input event is received. The motion-related input event may include a touch event that occurs on a defined input area or a part of an entire area of the display 140. Alternatively, the motion-related event may include a sensor event, such as, for example, tilting, shaking, or tapping on the electronic device 100. If the motion-related input event is not received, operation 311 is skipped, and the methodology proceeds to operation 313.

If the motion-related input event occurs, the object processing module 160 controls performance of a function or a motion of the input control object based on the input event, in operation 311. For example, the object processing module 160 may move the input control object on the display 140 in response to the motion-related input event. The object processing module 160 may control a displaying operation according to at least one of a motion of selecting an item that is output to the display 140 by moving the input control object, a motion of overlapping at least a part of the input control object and at least a part of the item, or a motion of changing a moving speed or a moving direction of the input control object adjacent to the item, in response to the motion-related input event. According to an embodiment of the present disclosure, when an event related to execution or selection of an item occurs, the object processing module 160 may allow a function related to the item to be executed. According to an embodiment of the present disclosure, the object processing module 160 may allow a predetermined function to be executed if the input control object is operated as a predefined input gesture.

In operation 313, the object processing module 160 determines whether an event occurs for releasing the operation of the input control object. For example, the object processing module 160 may determine whether an event occurs for terminating a function set for operating the input control object, a predetermined event related to removal of the input control object occurs, or an event occurs for switching to a function to which the operation of the input control object is not applied. If the event for releasing the operation of the object processing module 160 does not occur, the process returns to operation 309. If the event for releasing the operation of the object processing module 160 occurs, the object processing module 160 removes the input control object, in operation 315. For example, the object processing module 160 may remove a plurality of input control objects at one time according to the type or a characteristic of the event for releasing the operation of the input control object.

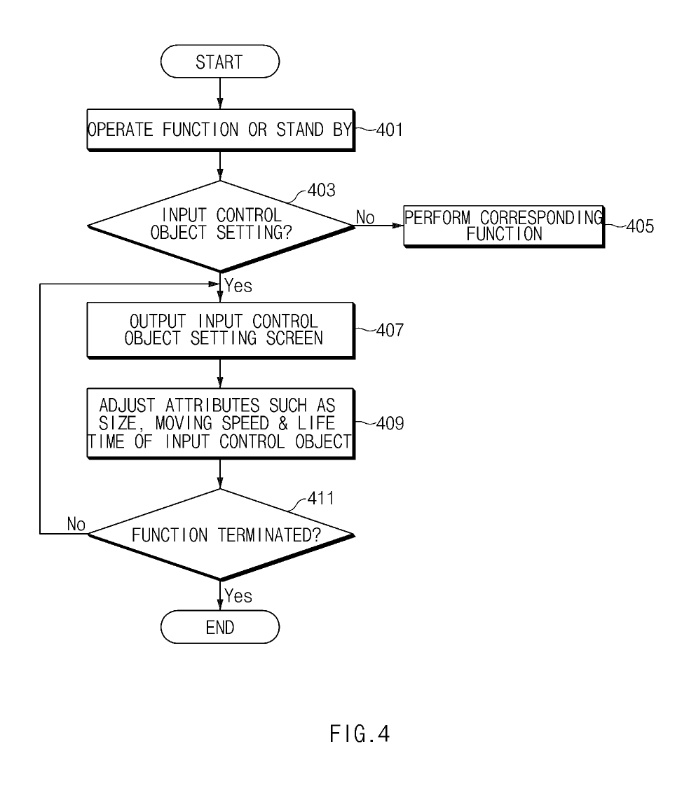

FIG. 4 is a flowchart illustrating an input control object setting method, according to an embodiment of the present disclosure.

Referring to FIG. 4, according to the input control object setting method, the object processing module 160 controls a functional operation or a standby operation, in operation 401. For example, the object processing module 160 may output a standby screen or a menu screen. Alternatively, the object processing module 160 may output a specific function execution screen. Alternatively, the object processing module 160 may control the operation of the input control object. According to an embodiment of the present disclosure, the object processing module 160 may provide a menu item or an icon related to the setting of the input control object. Alternatively, the object processing module 160 may control assignment of a key related to the setting of the input control object.

The object processing module 160 determines whether an event related to the setting of the input control object occurs, in operation 403. If an event related to the setting of the input control object does not occur, the object processing module 160 performs a function corresponding to the type of the event that has occurred or maintains a previous function, in operation 405.

If there an event related to the setting of the input control object or an event of generating the input control object occurs, the object processing module 160 outputs an input control object setting screen, in operation 407. For example, the object processing module 160 may determine whether an event occurs for a key, a menu, or an icon assigned in relation to the setting of the input control object. Alternatively, the object processing module 160 may determine whether an event related to generation of the input control object occurs. In operation 409, the object processing module 160 adjusts at least one of a size, moving speed, shape, and lifetime of the input control object, in response to an event that occurs through at least one of the display 140 having an input function and the input/output interface 130.

In operation 411, the object processing module 160 determines whether an event occurs for terminating an input control object setting function. The object processing module 160 may terminate the setting of the input control object when a function-termination-related event occurs. In operation 411, the object processing module 160 may remove the input control object setting screen from the display 140. When the input control object setting screen is terminated, the process may return to operation 401. According to an embodiment of the present disclosure, when the setting of the input control object is terminated, the process may proceed to operation 307 of FIG. 3. Alternatively, according to an embodiment of the present disclosure, the object processing module 160 may allow the electronic device to enter a sleep mode (e.g., a state in which power supply is blocked from the display module, a state in which a function of a designated application is temporarily suspended, a state in which a designated application is terminated, or a state in which a designated task is maintained in a standby mode) if a designated event does not occur for a designated time. Alternatively, according to an embodiment of the present disclosure, the object processing module 160 may turn off the electronic device if the function-termination-related event is related to turning off power.

If the event for terminating the input control object setting function does not occur, the process returns to operation 407. The object processing module 160 may support setting of a new input control object or may support a setting change of the input control object. According to various embodiments of the present disclosure, an input control object operating method according to an embodiment of the present disclosure may include outputting at least one input control object to a display in response to an event that occurs in an electronic device, moving the input control object on the display in a direction and at a speed designated on the basis of a first event, and performing a function related to the input control object on the basis of a second event.

According to various embodiments of the present disclosure, the outputting may include any one of outputting the input control object to a designated location on the display or a certain location on the display related to an occurrence location of the event (related to output of the input control object).

The method may include collecting an event occurring on a designated area of the display, and outputting at least one virtual input control object that is controlled to be able to be moved to a certain location on a screen of the display or requests processing of a designated function at a specific location in response to the event.

According to various embodiments of the present disclosure, the method may further include moving the input control object in response to occurrence of an event.

According to various embodiments of the present disclosure, the method may further include at least one of removing an item selected according to movement of the input control object, executing a function supported by the item selected according to the movement of the input control object, moving a location of the item selected according to the movement of the input control object, or outputting a specific function execution screen to the display according to a designated motion of the input control object. According to various embodiments of the present disclosure, the moving may include changing at least one of a moving speed, a size, a location, a shape or a duration of life of the input control object on the basis of a relative location of the input control object with respect to the item output to the display.

According to various embodiments of the present disclosure, the changing may include at least one of changing a moving speed of the input control object if the input control object approaches within a specific distance from the item output to the display or at least a part of the input control object overlaps the item, changing the moving speed of the input control object if the input control object is spaced apart from the item output to the display by at least the specific distance or an overlap between the input control object and the item is released, changing a size of the input control object if the input control object approaches within the specific distance from the item output to the display or at least a part of the input control object overlaps the item, changing the size of the input control object if the input control object is spaced apart from the item output to the display by at least the specific distance or the overlap between the input control object and the item is released, or moving the input control object so that the input control object is adjacent to the item if the input control object approaches within the specific distance from the item output to the display.

According to various embodiments of the present disclosure, an input control object operating method according to an embodiment of the present disclosure may include outputting at least one input control object that is moved to a certain location on a screen of a display of an electronic device or requests processing of a function in response to an event occurring on a designated area of the display, moving the input control object in a certain direction or at a certain speed on the basis of a first event, and performing the function corresponding to a request of the input control object on the basis of a second event.

According to various embodiments of the present disclosure, the outputting may include outputting at least one input control object in response to at least one of occurrence of a specified touch event, occurrence of a specified sensor event, occurrence of a specified virtual button selection event, occurrence of a specified hardware button selection event, occurrence of a specified touch event on a certain area of the display, execution of a specific function, or occurrence of a plurality of specified touch events.

According to various embodiments of the present disclosure, the performing the function may include outputting a specific function execution screen to the display according to a motion of the input control object.

According to various embodiments of the present disclosure, the performing the function may include at least one of removing an item selected according to movement of the input control object, executing a function supported by the item selected according to the movement of the input control object, or moving a location of the item selected according to the movement of the input control object.

According to various embodiments of the present disclosure, the moving may include moving the input control object in response to a touch event that occurs on an uppermost layer.

According to various embodiments of the present disclosure, the moving may include changing at least one of a moving speed, a size, a location, a shape or a duration of life of the input control object on the basis of a relative location of the input control object with respect to the item output to the display.

According to various embodiments of the present disclosure, the changing may include changing at least one of the moving speed or the size of the input control object on the basis of a distance between the input control object and the item output to the display or whether the input control object and the item output to the display overlap each other.

According to various embodiments of the present disclosure, the changing may include moving the input control object so that the input control object is adjacent to the item output to the display when the input control object approaches within a specific distance from the item.

According to various embodiments of the present disclosure, the method may further include at least one of assigning an input area for generating a touch event related to movement control of the input control object, or outputting a map related to movement of the input control object.

According to various embodiments of the present disclosure, the method may further include adjusting at least one of a function application attribute, a movement-related attribute, or a life time of the input control object according to a third event.

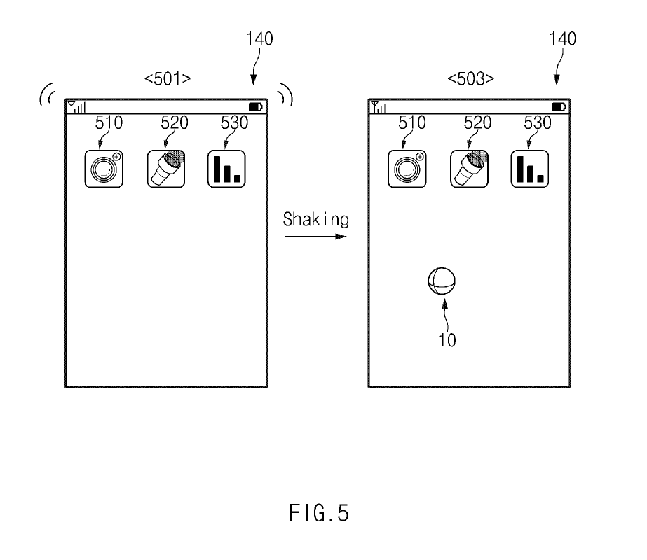

FIG. 5 is a diagram illustrating generation of the input control object, according to an embodiment of the present disclosure.

Referring to FIG. 5, the electronic device 100 includes a sensor module. The object processing module 160 receives a specific sensor event collected by the sensor module, such as, for example, a shaking event, as illustrated in a state 501. When the sensor event occurs, the object processing module 160 outputs an input control object 10 to a certain area, as illustrated in a state 503.

According to an embodiment of the present disclosure, the sensor event related to a call of the input control object 10 may include various events, such as, for example, a tilting event in which the electronic device 100 is tilted at a certain angle or higher, a tap event in which a certain area of the electronic device 100 is tapped, and a panning event in which the electronic device 100 is rotated. For example, when the electronic device 100 is rotated to be switched from a landscape mode to a portrait mode, or from the portrait mode to the landscape mode, the object processing module 160 may output the input control object 10. The object processing module 160 may enable a specific sensor included in the sensor module, such as, for example, an acceleration sensor or a geomagnetic sensor, in relation to the calling of the input control object 10.

According to an embodiment of the present disclosure, the display 140 outputs a screen including at least one item, e.g., a first item 510, a second item 520, and a third item 530, as illustrated in the state 501. The screen output to the display 140 may be a standby screen. When a set sensor event occurs, the object processing module 160 may output the input control object 10 to an area so that the input control object does not overlap the items 510, 520, and 530. Alternatively, the object processing module 160 may output the input control object 10 so that at least a part of the input control object 10 overlaps a specific item, such as the first item 510. Alternatively, the object processing module 160 may output the input control object 10 so that the input control object 10 overlaps the second item 520 or the third item 530. The object processing module 160 may output the input control object 10 in such a manner that the input control object 10 overlaps a most-frequently selected item among the items 510, 520, and 530. The object processing module 160 may store and manage history information on selection frequencies of the items 510, 520, and 530. The input control object 10 may also be output to a location designated by the user.

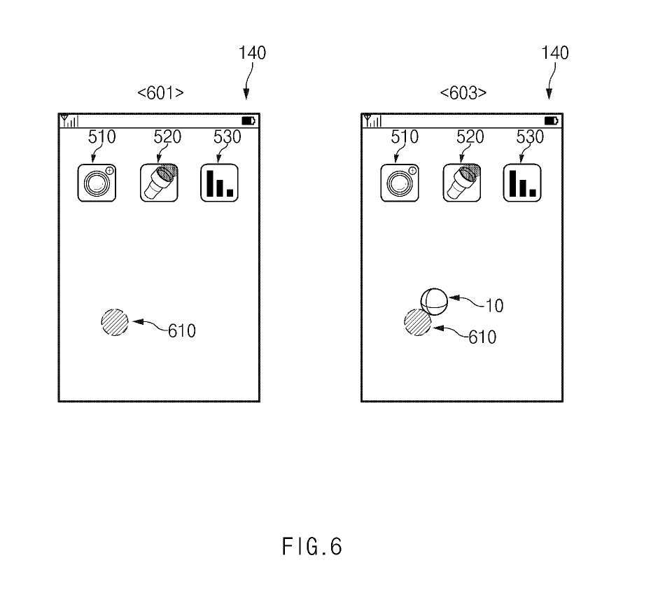

FIG. 6 is a diagram illustrating generation of the input control object, according to another embodiment of the present disclosure.

Referring to FIG. 6, the display 140 outputs a screen including at least one item, i.e., items 510, 520, and 530, as illustrated in a state 601. The object processing module 160 may enable a touch panel in relation to touch function of the display 140.

The object processing module 160 collects a touch event in relation to the calling of the input control object 10. For example, the user touches a certain location 610 of the display 140 using a touch means, such as, for example, a finger or an electronic pen. The display 140 provides, to the object processing module 160, a touch event occurring at the certain location 610. In response to the touch event occurring at the certain location 610, the object processing module 160 outputs the input control object 10, as illustrated in a state 603.

According to an embodiment of the present disclosure, the object processing module 160 outputs the input control object 10 when a specified touch event occurs on the predefined certain location 610. Alternatively, the object processing module 160 may output the input control object 10 to the display 140 when a predefined touch event occurs. For example, the object processing module 160 may output the input control object 10 when a touch event corresponding to a long press occurs. The object processing module 160 may maintain the output of the input control object 10 regardless (independent) of whether the touch event corresponding to the long press is released. The input control object 10 may be output to at least one of a location where the touch event occurs, a location spaced apart from the location where the touch event occurs by a specific distance, or a location designated by the user. According to an embodiment of the present disclosure, the object processing module 160 may generate a layer or may use an existing layer to output the input control object 10. Accordingly, a layer on which the items 510, 520, and 530 are arranged and a layer on which the input control object 10 is disposed may overlap each other on the display 140. The layer including the input control object 10 may be disposed at an uppermost layer or another location. The object processing module 160 may move or operate the input control object 10 in response to the touch event occurring on the layer on which the input control object 10 is disposed. When the touch event occurs on an area on which the items 510 to 530 are arranged while the layer including the input control object 10 is disposed at the uppermost layer, the object processing module 160 may recognize the touch event as being related to control of the input control object 10. When the input control object 10 is removed, the object processing module 160 may remove the layer on which the input control object 10 is disposed. According to an embodiment of the present disclosure, when the touch event occurs on the area on which the items 510, 520, and 530 are arranged, the object processing module 160 may support execution of a function related to an item selected by the touch event. The object processing module 160 may remove the layer on which the input control object 10 is disposed. In another example, the object processing module 160 may process the touch event occurring on an area of an item associated with a disposition state of the input control object 10 (e.g., an item at least a part of which is overlapped with the input control object 10, or an item disposed within a designated distance from the input control object 10) regardless of a location of the layer including the input control object 10, in relation to the item. For example, the object processing module 160 may control selection of an item according to the touch event or execution of an application related to the item. The object processing module 160 may simultaneously perform control of the input control object and control of the item. For example, the object processing module 160 may simultaneously stop moving the input control object and select the item or execute a function related to the item.

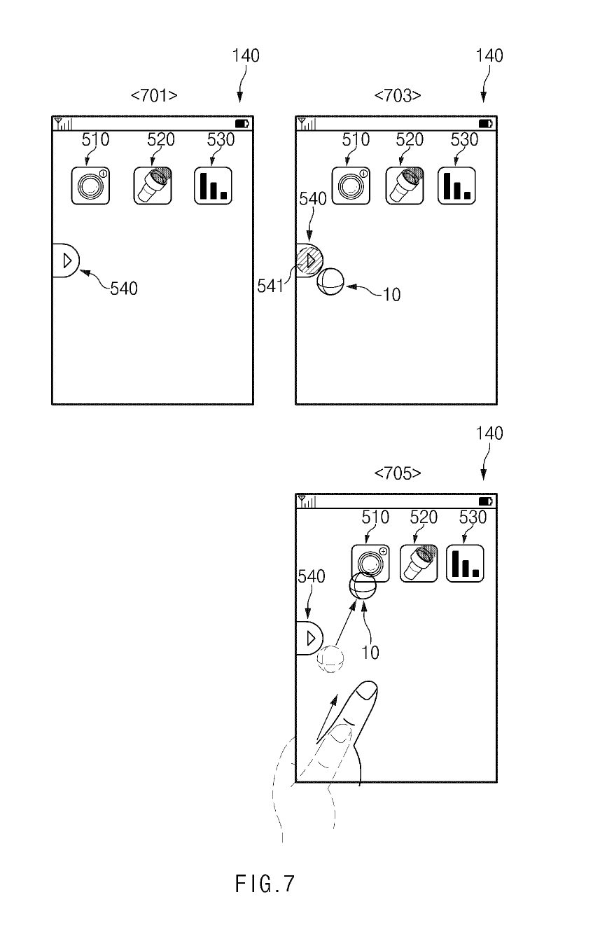

FIG. 7 is a diagram illustrating movement of the input control object based on a touch event, according to an embodiment of the present disclosure.

Referring to FIG. 7, the display 140 outputs a specific function screen or a standby screen, as illustrated in a state 701. The display 140 outputs a screen including at least one item, i.e., items 510, 520, and 530, and a virtual control button 540. The items 510, 520, and 530 may be icons related to execution of specific functions. According to an embodiment of the present disclosure, the virtual control button 540 has a function of calling the input control object 10. The object processing module 160 outputs the input control object 10 when a specific touch event 541 occurs on the virtual control button 540, as illustrated in a state 703. The input control object 10 may be disposed on an adjacent area to the virtual control button 540.

According to an embodiment of the present disclosure, when the input control object 10 is output, the object processing module 160 may output a layer including the input control object 10 as an uppermost layer. As illustrated in the state 703, when a touch event occurs on the uppermost layer on which the input control object 10 is disposed, the object processing module 160 may recognize the touch event as being related to the operation of the input control object 10. For example, the object processing module 160 may move the input control object 10 according to the touch event.

According to an embodiment of the present disclosure, the object processing module 160 moves the input control object 10 in response to the touch event, as illustrated in a state 705. The object processing module 160 moves the input control object 10 by a distance corresponding to a distance of a touch-and-drag. According to an embodiment of the present disclosure, the touch event may be a flick event or a swing event. The object processing module 160 may move the input control object 10 in a specific direction at a certain speed or with a certain acceleration in response to the flick event. To control movement of the input control object 10 in response to the flick event, a moving speed of the input control object 10 may be controlled based on a speed (or intensity) of a flick. The input control object 10 may be overlaid with at least one item, for example, the first item 510, while being moved. In the case where the input control object 10 is overlaid with the first item 510 while being moved, the object processing module 160 may display a color obtained by combining a color of the first item 510 with a color of the input control object 10.

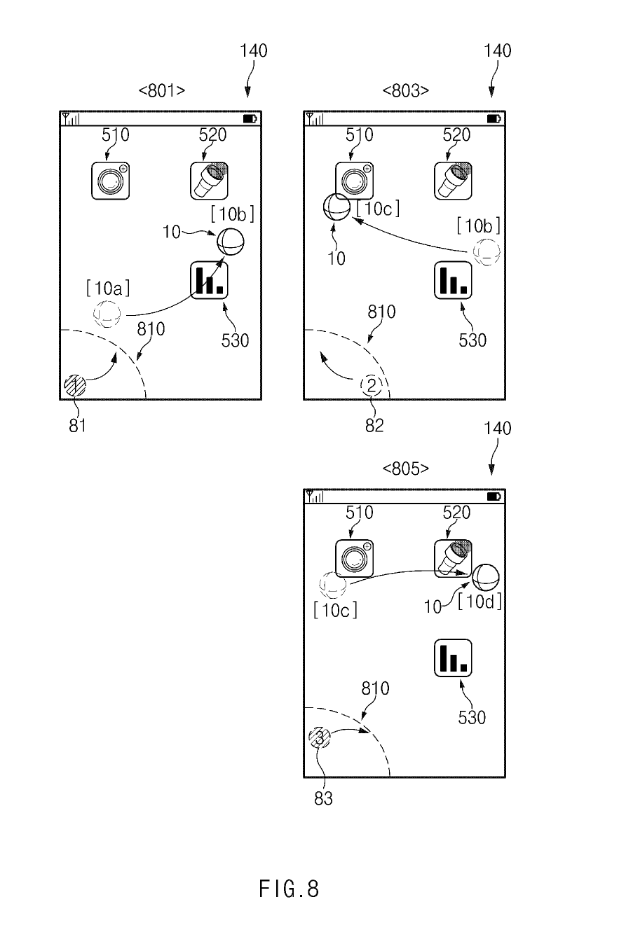

FIG. 8 is a diagram illustrating movement of the input control object based on a touch event, according to another embodiment of the present disclosure.

Referring to FIG. 8, when a predetermined event, such as a specified touch event, occurs within a predefined input area 810, the object processing module 160 recognizes the specified touch event as being related to the call of the input control object 10. Accordingly, the object processing module 160 outputs the input control object 10 to a certain area of the display 140. The object processing module 160 outputs the input control object 10 to a certain area adjacent to the input area 810, for example, a First location 10a. Accordingly, the display 140 outputs the input control object 10 and the items 510, 520, and 530, as illustrated in a state 801. According to an embodiment of the present disclosure, a screen on which an item is not disposed or the input control object 10 alone is disposed may be output to the display 140. Furthermore, the input area 810 related to control of the input control object 10 may be defined on the display 140. The input area 810 may be defined on at least a part of the layer including the items 510, 520, and 530. Alternatively, the input area 810 may be defined on a layer that is higher than the layer on which the items 510, 520, and 530 are arranged. The input control object 10 may be disposed on the layer on which the input area 810 is disposed.

According to an embodiment of the present disclosure, a first touch event 81 occurs on the input area 810, as illustrated in the state 801. The first touch event 81 may be a flick moving in a direction from a lower left side to an upper right side. The object processing module 160 moves the input control object 10 from the first location 10a to a second location 10b in response to the first touch event 81. The object processing module 160 may control the movement of the input control object 10 according to a degree of motion of the flick. For example, the object processing module 160 may apply a moving direction, an initial moving speed, a middle (or midterm) moving speed, or a final (or late) moving speed of the input control object 10 according to a moving speed, a movement distance, or a moving speed of the flick.

According to an embodiment of the present disclosure, when the input control object 10 starts to move in response to an input event, the input control object 10 may continuously move. For example, when the first touch event 81 occurs on the input area 810, the input control object 10 may start to move in response to the first touch event 81. The input control object 10 may continue to move at a certain speed until an additional touch event occurs. The input control object 10 may move according to at least one of an initial moving direction or an initial moving speed corresponding to a degree of motion of a touch of the first touch event 81. The input control object 10 may move at a predefined certain speed after traveling a specific distance at an initial moving speed.

According to an embodiment of the present disclosure, the input control object 10 bounces against an edge of the display 140 if the input control object 10 moves adjacent to the edge of the display 140. A bouncing direction may be a direction of a reflection angle corresponding to an incidence angle. While the input control object 10 bounces against an edge of the display 140, the object processing module 160 may control representation of distortion of the input control object 10. According to an embodiment of the present disclosure, the object processing module 160 may change the moving speed of the input control object 10 for a certain time while the input control object 10 is bounced. For example, the object processing module 160 may render the moving speed of the input control object 10 measured during an interval between a time at which the input control object 10 is bounced and a time at which the certain time expires different from the moving speed of the input control object 10 measured after the certain time expires. The object processing module 160 may allow the input control object 10 to move in a certain direction and at a certain speed within a boundary defined by an edge of the display 140.

According to an embodiment of the present disclosure, if the input control object 10 exits an edge of the display 140, the object processing module 160 may allow the input control object 10 to enter at a different edge of the display 140. For example, if the input control object 10 moves downwards and exits the screen at a lower edge of the display 140, the object processing module 160 may allow the input control object 10 to enter from at an upper edge of the display 140.

According to an embodiment of the present disclosure, a second touch event 82 occurs on the input area 810, as illustrated in a state 803. The second touch event 82 may be a flick moving in a direction from a lower right side to an upper left side. The object processing module 160 moves the input control object 10 according to a moving direction of the second touch event 82 on the display 140 on which the items 510, 520, and 530 are arranged. For example, the object processing module 160 moves the input control object 10 from the second location 10b to a third location 10e in response to the second touch event 82. The input control object 10 positioned on the second location 10b may be in a state of being bounced against a right edge of the display 140 or in a state of exiting the screen at the right edge of the display 140. In the case of any state, the object processing module 160 adjusts the moving direction and the moving speed of the input control object 10 in response to the second touch event 82.

According to an embodiment of the present disclosure, a third touch event 83 occurs on the input area 810, as illustrated in a state 805. The third touch event 83 may be a flick moving in a direction from a left side to a right side. The object processing module 160 moves the input control object 10 according to the third touch event 83 on the display 140 on which the items 510, 520, and 530 are displayed. Accordingly, the input control object 10 is moved from the third location 10c to a fourth location 10d.

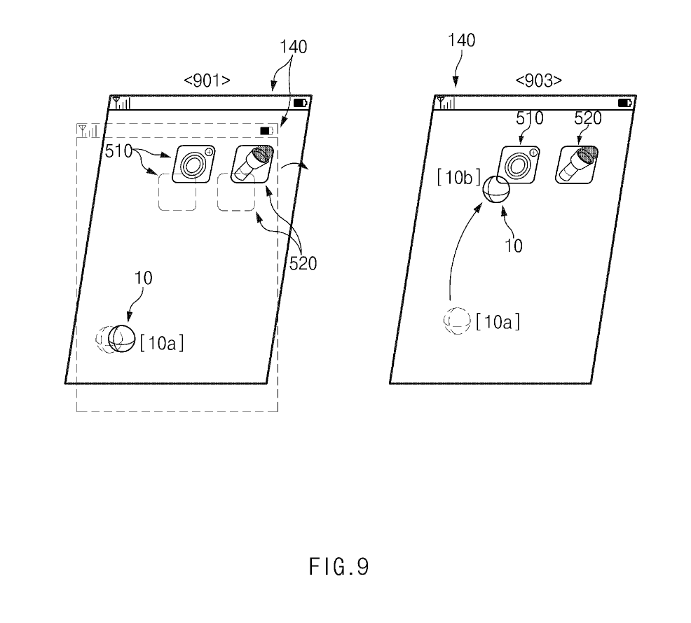

FIG. 9 is a diagram illustrating operation of the input control object based on a sensor event, according to an embodiment of the present disclosure.

Referring to FIG. 9, the display 140 outputs a screen including the items 510 and 520, as illustrated in a state 901. Furthermore, the display 140 outputs the input control object 10 in response to a predetermined event or an event related to the calling of the input control object 10. The object processing module 160 enables the sensor module of the electronic device 100. The object processing module 160 receives a tilting event from the sensor module if the electronic device 100 is tilted at a certain angle, as illustrated in the state 901. Upon receiving the tilting event, the object processing module 160 moves the input control object 10, as illustrated in a state 903. According to an embodiment of the present disclosure, the object processing module 160 moves the input control object 10 from the first location 10a to the second location 10b.

According to an embodiment of the present disclosure, if the electronic device is tilted back to an original position, the object processing module 160 may move the input control object 10 from the second location 10b to the first location 10a. Furthermore, the object processing module 160 may control the movement and display of the input control object 10 according to a tilting direction of the electronic device. For example, if the electronic device 100 is tilted from left to right, the object processing module 160 may move the input control object 10 from left to right. Alternatively, if the electronic device 100 is tilted from right to left, the object processing module 160 may move the input control object 10 from right to left. The moving speed or a moving direction of the input control object may change according to a tilting angle and a tilting direction.

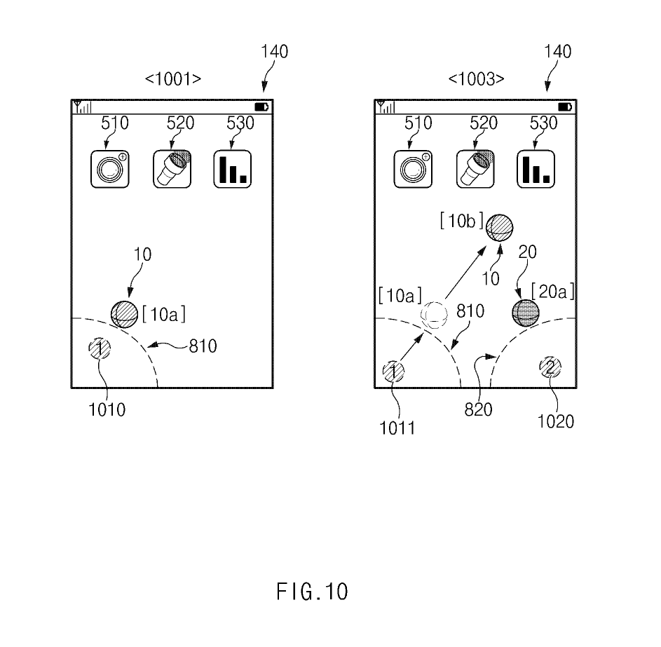

FIG. 10 is a diagram illustrating operation of a plurality of input control objects, according to an embodiment of the present disclosure.

Referring to FIG. 10, the display 140 outputs the items 510, 520, and 530 in relation to execution of a specific function or output of a standby screen, as illustrated in a state 1001. When a predetermined event occurs, the object processing module 160 outputs the first input control object 10 to a certain area of the display 140. For example, when a first touch event 1010 occurs on the predefined first input area 810, the object processing module 160 outputs the first input control object 10 to an area (e.g., the first location 10a) adjacent to the first input area 810. Alternatively, when the first touch event 1010 occurs on the display 140 on which the items 510, 520, and 530 are displayed, the object processing module 160 may output the first input control object 10 and may define the first input area 810. The first input control object 10 and the first input area 810 may be arranged on the same layer. The layer on which the first input control object 10 and the first input area 810 are arranged may be different from a screen layer on which the items 510, 520, and 530 are arranged.

According to an embodiment of the present disclosure, when a second touch event 1020 occurs, the object processing module 160 outputs a second input control object 20 to a certain area of the display 140. For example, the object processing module 160 outputs the second input control object 20 to a designated area 20a in response to the second touch event 1020. The certain location 20a may be defined within a specific distance from a location where the second touch event 1020 has occurred. According to an embodiment of the present disclosure, the second input control object 20 may be disposed in an area adjacent to the second input area 820. Accordingly, the display 140 displays the plurality of input control objects 10 and 20.

According to an embodiment of the present disclosure, when a movement touch event 1011 related to movement of the first input control object 10 occurs, the object processing module 160 moves the first input control object 10 from the first location 10a to the second location 10b. For example, when the movement touch event 1011 occurs on the first input area 810, the object processing module 160 recognizes the event as being related to the movement of the first input control object 10. According to an embodiment of the present disclosure, when the movement touch event 1011 is a drag event, the first input control object 10 may be moved in a certain direction and by a specific distance corresponding to a dragging direction and distance. The first input control object 10 may be moved by as much as a certain ratio to the dragging distance of the drag event occurring on the first input area 810. For example, if the drag event has a dragging distance of “1” on the first input area 810, the first input control object 10 may be moved by as much as a predetermined ratio to the dragging distance, for example, by a distance of “3”. According to an embodiment of the present disclosure, the movement touch event 1011 may be a flick event or a swing event. When the flick event or the swing event occurs, the object processing module 160 may move the first input control object 10 according to a direction and a moving speed of flicking. The first input control object 10 may be moved by a specific distance in an initial direction and at an initial speed, and then may be continuously moved in an arbitrary direction or a direction associated with the initial direction and at a predetermined speed after being moved by the specific distance. When a touch event related to stopping the first input control object 10 that is being moved (e.g., an event of tapping or touching down the first input area 810) occurs, the object processing module 160 may stop the movement of the first input control object 10.

According to an embodiment of the present disclosure, when a movement touch event occurs on the second input area 820, the object processing module 160 recognizes the event as being related to the movement of the second input control object 20. Accordingly, the object processing module 160 may control the movement of the second input control object 20. Therefore, the input control objects 10 and 20 may be continuously moved and displayed in a certain direction and at a certain speed. When the input control objects 10 and 20 collide with each other, the object processing module 160 may allow the input control objects 10 and 20 to continue to move moving in directions thereof or may change at least one of the direction or the speed of the input control objects 10 and 20 at the time of collision. The input control objects 10 and 20 may exist on different layers. For example, the first input control object 10 may have a priority over the second input control object 20, so that the first input control object 10 may be disposed on an uppermost layer and the second input control object 20 may be disposed on a second uppermost layer.

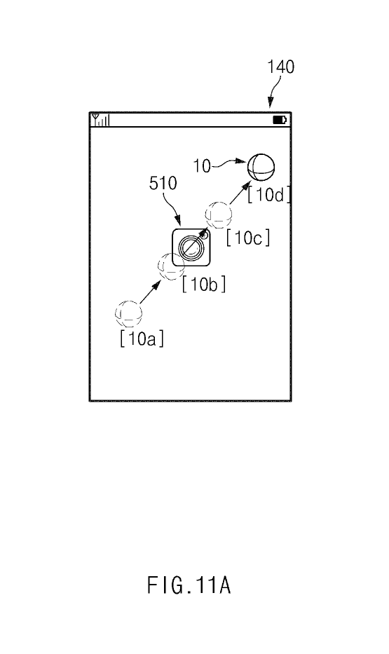

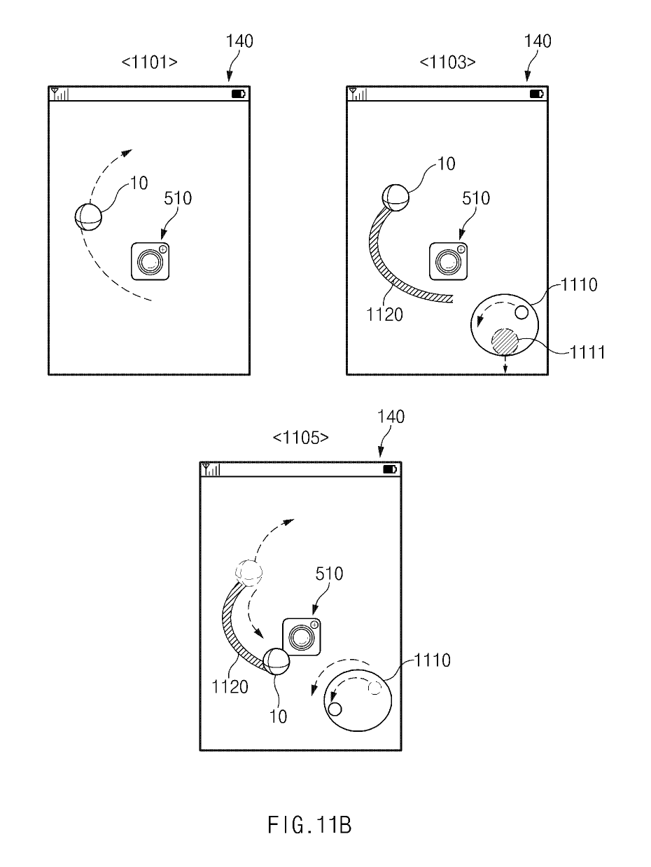

FIG. 11A is a diagram illustrating movement of the input control object associated with a display item, according to an embodiment of the present disclosure.

Referring to FIG. 11A, the display 140 outputs the first item 510 in response to execution of a specific function or output of a standby screen. The object processing module 160 outputs the input control object 10 to a certain location of the display 140 in response to the call of the input control object 10. The input control object 10 is moved and displayed in a certain direction and at a certain speed in response to an input event. For example, the input control object 10 is moved and displayed in a direction from the first location 10a to the second location 10b and at a first speed. Furthermore, the input control object 10 is moved and displayed in a direction from the second location 10b to the third location 10c and at a second speed. The second speed may be different from the first speed, for example, may be slower (or faster) than the first speed. The input control object 10 is moved and displayed in a direction from the third location 10c to the fourth location 10d at a third speed. The third speed may be faster (or slower) than the second speed. The third speed may be the same as the first speed. As described above, the object processing module 160 may change the moving speed of the input control object 10 if at least a part of the input control object 10 overlaps at least a part of the object 510 (e.g., an icon, a widget or an indicator) displayed on the display 140 while the input control object 10 is moved. Furthermore, when the overlap no longer occurs, the object processing module 160 may change the moving speed of the input control object 10.

According to an embodiment of the present disclosure, if a specific event occurs when the input control object 10 overlaps the first item 510, the object processing module 160 may control execution of a function related to the first item 510. The specific event may be a double tap event or a long press event. According to an embodiment of the present disclosure, when the first item 510 is an icon related to Internet access, the object processing module 160 may perform Internet access based on an address of a predefined specific server device. Alternatively, when the first item 510 is an icon related to a call function, the object processing module 160 may output a dial screen or may make a call to another predefined electronic device in response to the event. Alternatively, when the first item 510 is a picture file, the object processing module 160 may display the picture file in a full screen mode or may delete the picture file.

FIG. 11B is a diagram illustrating movement control of the input control object, according to an embodiment of the present disclosure.

Referring to FIG. 11B, according to an embodiment of the present disclosure, in response to a first event, the object processing module 160 outputs the input control object 10 to the display 140 on which the first item 510 is disposed, as illustrated in a state 1101. The object processing module 160 moves the input control object 10 in a certain direction in response to a first event or a second event. When a touch event 1111 related to stopping the input control object 10 is received, the object processing module 160 stops the input control object 10 at the time of receiving the touch event 1111, as illustrated in a state 1103. The object processing module 160 outputs an object (e.g., a virtual jog-shuttle 1110) related to a movement path of the input control object 10 on one side of the display 140. By virtue of operation of the virtual jog-shuttle 1110, the object processing module 160 may rewind the input control object 10 in response to a specific event that occurs. By rewinding the input control object 10, the user may more easily select the first item 510, as illustrated in a state 1105. According to an embodiment of the present disclosure, when the input control object 10 is stopped, the object processing module 160 outputs, on one side of the display 140, a path 1120 with a certain length that the input control object 10 has followed. If a certain location of the path 1120 is selected, the object processing module 160 may move the input control object 10 to the location. The path 1120 may be displayed on an actual path that the input control object 10 has followed. Alternatively, the path 1120 may be reduced to a certain size, and then may be displayed on an edge of the display 140, for example, a lower left end or a lower right end thereof.

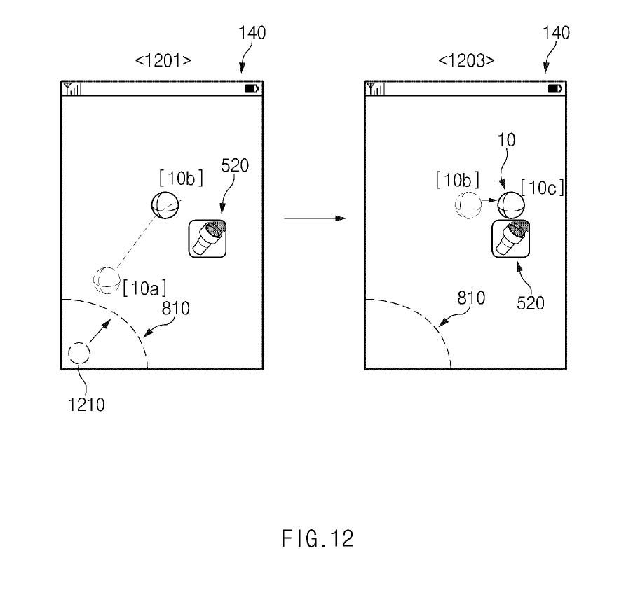

FIG. 12 is a diagram illustrating movement of the input control object associated with a display item, according to another embodiment of the present disclosure.

Referring to FIG. 12, the display 140 outputs the item 520 in relation to execution of a specific function or output of a standby screen, as illustrated in a state 1201. According to an embodiment of the present disclosure, when an event related to the calling of the input control object 10 occurs, the object processing module 160 outputs the input control object 10 to a part of the display 140. The object processing module 160 defines the input area 810 related to movement or operation of the input control object 10 on a certain area of the display 140. When a movement touch event 1210 occurs on the input area 810, the object processing module 160 moves the input control object 10 in a direction from the first location 10a to the second location 10b.

According to an embodiment of the present disclosure, when the input control object 10 approaches within a specific distance from the item 520, the object processing module 160 moves the input control object 10 to an adjacent location (e.g., the third location 10c) to the item 520, as illustrated in a state 1203. Alternatively, the object processing module 160 may move the input control object 10 to the third location 10c where the input control object 10 contacts the item 520. The movement of the input control object 10 to the item 520 may be automatically performed without occurrence of an additional movement touch event.

According to an embodiment of the present disclosure, a specific event (e.g., a touch event, a hovering event, an input event by a hardware button, or a gesture recognition event based on a sensor) may occur while at least a part of the item 520 overlaps the input control object 10, or when the input control object 10 is disposed within a specific distance from the item 520. The object processing module 160 may then perform a function related to the item 520. For example, when the item 520 is an icon of a flashlight function, the object processing module 160 may turn on the flashlight function. When the item 520 is an icon of a camera function, the object processing module 160 may activate the camera function.

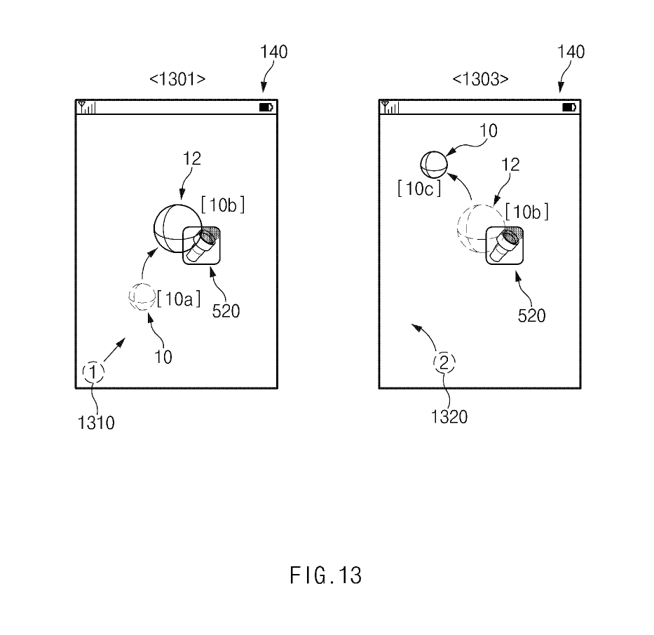

FIG. 13 is a diagram illustrating modification of the input control object associated with a display item, according to an embodiment of the present disclosure.

Referring to FIG. 13, the display 140 outputs the item 520 to a certain location in relation to execution of a specific function or output of a standby screen, as illustrated in state 1301. According to an embodiment of the present disclosure, when an event related to the call of the input control object 10 occurs, the object processing module 160 outputs the input control object 10 to a part of the display 140. For example, the input control object 10 is output to the first location 10a. When outputting the input control object 10, the object processing module 160 may not define an additional input area. The object processing module 160 may define the entirety or at least a part of the display 140 as an input area. According to an embodiment of the present disclosure, the object processing module 160 may it) output an input area for generating an event related to movement or selection of the input control object 10 as illustrated in, for example, FIG. 12.

According to an embodiment of the present disclosure, when a first touch event 1310 occurs on a certain area of the display 140, the object processing module 160 moves the input control object 10 in a direction from the first location 10a to the second location 10b. When at least a part of the input control object 10 overlaps the item 520, or approaches within a specific distance of the item 520, the object processing module 160 changes the size of the input control object 10. For example, the object processing module 160 may increase or decrease the size of the input control object 10 to a predetermined size. The object processing module 160 may facilitate selection of the item 520 using a size-modified input control object 12.

According to an embodiment of the present disclosure, when the size-modified input control object 12 is spaced apart from the item 520 by a specific distance or greater, or the size-modified input control object 12 no longer overlaps the item 520, the object processing module 160 changes the size of the size-modified input control object 12. For example, the object processing module 160 reduces the size of the size-modified input control object 12, as illustrated in a state 1303. The reduced size of the input control object 10 may correspond to the size of the input control object 10 disposed at the first location 10a.

According to an embodiment of the present disclosure, the size-modified input control object 12 is moved from the second location 10b to the third location 10c in response to a second touch event 1320. According to an embodiment, if the size-modified input control object 12 is spaced apart from the item 520 by a specific distance or longer or the overlap therebetween is released, the object processing module 160 may change the size of the size-modified input control object 12.

The state 1303 illustrates that a direction change occurs in response to the second touch event 1320. The input control object 10 is moved from the first location 10a to the second location 10b in response to the first touch event 1310. When the second touch event 1320 does not occur, the input control object 12 may continuously move in a direction from the first location 10a to the second location 10b. According to an embodiment, the size-modified input control object 12 may be restored to an original size or may maintain a designated size after being overlapped with the item 520 (e.g., after being moved so that an overlap area therebetween disappears). According to an embodiment of the present disclosure, the object processing module 160 may adjust the size of the input control object 10 according to a degree of concentration of items. For example, if the input control object 10 overlaps a specific item while other times are not disposed in areas adjacent to the specific item (e.g., within a designated radius or a designated distance), the object processing module 160 may change the size of the input control object 10 into a first size. If the input control object 10 overlaps the specific item while other items are disposed in areas adjacent to the specific item, the object processing module 160 may change the size of the input control object 10 into a second size. The second size may be smaller than the first size, may be calculated so that the input control object 10 does not overlap the other items, or may be determined in consideration of distances between the items.

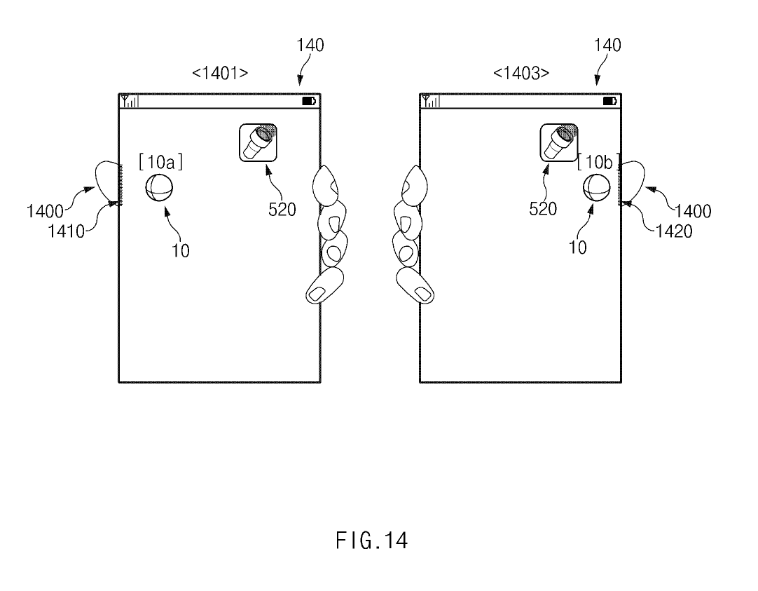

FIG. 14 is a diagram illustrating output of the input control object based on a grip direction, according to an embodiment of the present disclosure.

Referring to FIG. 14, the display 140 displays the item 520 in relation to execution of a specific function or output of a standby screen. When an event related to the call of the input control object 10 occurs, the object processing module 160 outputs the input control object 10 to the display 140. According to an embodiment of the present disclosure, when a grip object 1400 grips a certain location of the electronic device 100, for example, a first side part 1410, the object processing module 160 outputs the input control object 10 to the first location 10a, as shown in state 1401. In relation to this operation, the electronic device 100 may have a setting for outputting the input control object 10 to the display 140 when one side of the electronic device 100 is gripped. According to an embodiment of the present disclosure, when the grip object 1400 grips a certain location of the electronic device 100, for example, a second side part 1420, the object processing module 160 outputs the input control object 10 to the second location 10b, as shown in state 1403. The electronic device 100 may have a pressure sensor or a pressure detectable touch sensor disposed at one or more sides of the electronic device 100 so that the input control object 10 is output in response to a grip.

According to an embodiment of the present disclosure, the object processing module 160 outputs the input control object 10 to a preset location according to a grip direction. For example, the object processing module 160 outputs the input control object 10 to the first location 10a when a sensor event corresponding to a left-hand grip is collected. Alternatively, the object processing module 160 outputs the input control object 10 to the second location 10b when a sensor event corresponding to a right-hand grip is collected. According to an embodiment of the present disclosure, the object processing module 160 may respectively output input control objects to the first location 10a and the second location 10b when a both-hands grip occurs. When a plurality of input control objects are output, the object processing module 160 may define a left-side area with respect to a vertical center line of the display 140 as an input area related to a portion of the input control objects, and may define a right-side area as an input area related to the other input control objects.

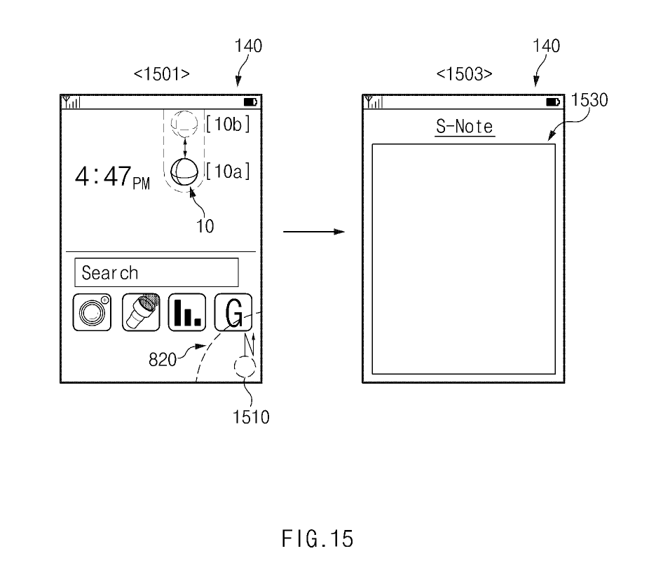

FIG. 15 is a diagram illustrating an execution function based on operation of the input control object, according to an embodiment of the present disclosure.

Referring to FIG. 15, the display 140 outputs a specific function execution screen, a standby screen, or a home screen, as illustrated in a state 1501. The object processing module 160 outputs the input control object 10 to the display 140 in response to an event related to the calling of the input control object 10. The input control object 10 is moved and displayed in response to an event. The object processing module 160 defines the input area 820 in relation to movement control of the input control object 10. When a first touch event 1510 occurs on the input area 820, the object processing module 160 controls a motion of the input control object 10 such that it corresponds to the first touch event 1510. The object processing module 160 receives an event corresponding to a motion of tapping or hitting, by the input control object 10, a certain area of an edge (e.g., an upper end area) of the display 140, at least a certain number of times, in response to the first touch event 1510. Accordingly, the input control object 10 is adjacent to an upper end edge of the display 140 while reciprocating between the first location 10a and the second location 10b at least a certain number of times. In response to a corresponding event, the object processing module 160 outputs a specific execution screen 1530 (e.g., a note function screen, or a quick panel (a screen for showing a received message of the electronic device 100 or a virtual layer for setting or switching a specific function)), as illustrated in a state 1503. For example, the object processing module 160 may control switching from a specific function execution screen to a home screen in response to a corresponding event. Accordingly, the object processing module 160 may support returning to the home screen in response to a gesture event on a specific area, which occurs on the basis of the input control object 10. Alternatively, the object processing module 160 may control movement from a current home screen to a next home screen. The specific function execution screen 1530 may be displayed on the display 140 through a screen switching effect. For example, the specific function execution screen 1530 may be displayed through screen switching, according to at least one of a method of swiping on a screen from left to right or downwards, a method of fading out a previous screen and fading in a new screen, and a method of gradually magnifying a screen to display the screen over the display 140. For example, the specific function execution screen 1530 may slide down like a curtain from an upper end of the display 140 to a lower end edge of the display 140.

According to an embodiment of the present disclosure, the object processing module 160 may control switching from a specific function execution screen to a home screen in response to a corresponding event. For example, when a gesture event based on the input control object 10 occurs on a specific area, the object processing module 160 may control switching to a specific function execution screen corresponding to the gesture event. A screen displayed on the display 140 by the gesture event may be at least one of screens not currently displayed on the display 140 among executed screens. Alternatively, the object processing module 160 may execute a specific function corresponding to the gesture event, and may display a screen corresponding to the specific function on the display 140.

According to an embodiment of the present disclosure, a predetermined event may occur while the input control object 10 is positioned on a certain area of the display 140, for example, an edge area thereof. In this case, the object processing module 160 may recognize the event as being related to execution of a specific function. When an event related to execution of a specific function is received, the object processing module 160 may output an execution screen of the specific function to the display 140. The object processing module 160 may display the execution screen of the specific function in a direction from an edge of the display 140 related to a location of the input control object 10 to another edge. According to an embodiment of the present disclosure, when the input control object 10 performs a specific gesture operation at a right edge of the display 140, the object processing module 160 may provide a display effect of moving the execution screen of the specific function in a direction from the right edge to a left edge of the display 140.

Although a note function screen is provided as an example of the specific function execution screen 1530 in FIG. 15, the embodiments of the present disclosure are not limited thereto. The specific function execution screen 1530 may be differently defined for each edge of the display 140. For example, a screen mapped to an upper edge of the display 140 may be a note screen, a screen mapped to a lower edge of the display 140 may be a calculator screen, a screen mapped to a left edge of the display 140 may be a weather screen, and a screen mapped to a right edge of the display 140 may be an Internet access screen. When there is no screen mapped to an edge of the display 140, the object processing module 160 may output a message indicating non-existence of a screen. The object processing module 160 may provide a setting screen for mapping a specific screen to an edge of the display 140.

According to an embodiment of the present disclosure, a plurality of screens may be mapped to a specific edge of the display 140. For example, a sound source playback function screen, a broadcast receiving function screen, a call function screen, an Internet screen, or the like, may be mapped to the left edge of the display 140. In the case where the input control object 10 repeatedly performs a specific gesture operation at the right edge of the display 140, the object processing module 160 may sequentially display the mapped screens on the display 140.

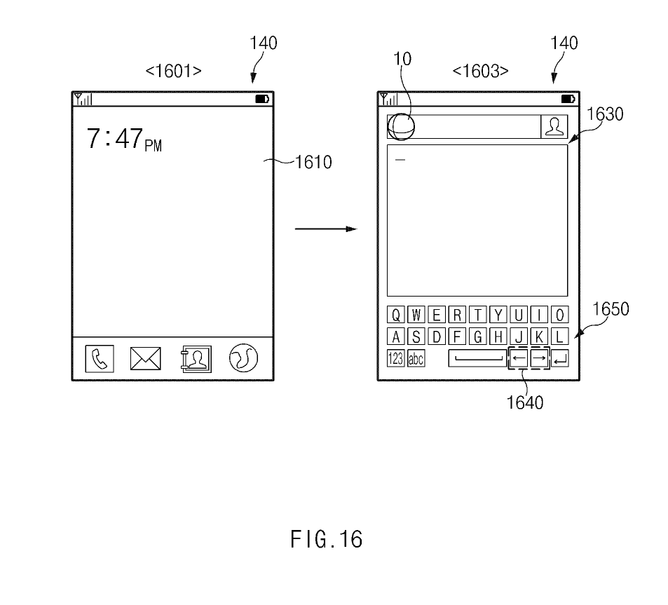

FIG. 16 is a diagram illustrating the operation of the input control object associated with execution of a function, according to an embodiment of the present disclosure.

Referring to FIG. 16, the display 140 outputs a specific function screen or a standby screen as a default screen, as illustrated in a state 1601. If a specific item is selected, a specific function is called, or a specific function is executed according to scheduling, the object processing module 160 outputs a function execution screen 1630 according to execution of a corresponding function, as illustrated in a state 1603. The object processing module 160 determines whether the input control object 10 is set for a function being executed. If the input control object 10 is set for the function, the object processing module 160 outputs the input control object 10 to a part of the function execution screen 1630, as illustrated in FIG. 16.

According to an embodiment of the present disclosure, the input control object 10 is set for a message function. If selection of an icon related to the message function or an event of requesting execution of the function occurs in the state 1601, the object processing module 160 outputs the message function execution screen as illustrated in the state 1603 while executing the message function. The object processing module 160 outputs the input control object 10 to a certain location of the message function execution screen 1630. For example, the object processing module 160 may output the input control object 10 to a certain location for inputting recipient information on the message function execution screen 1630. When an event related to control of the input control object 10 occurs, the object processing module 160 may locate a cursor on a recipient information input field.

According to an embodiment of the present disclosure, the object processing module 160 provides virtual movement key buttons 1640 related to location movement of the input control object 10 on a part of the function execution screen 1630. For example, the object processing module 160 provides the virtual movement key buttons 1640 in an area where message input buttons 1650 are arranged. According to an embodiment of the present disclosure, the object processing module 160 assigns at least one of the message input buttons 1650 as a virtual key button related to control of the input control object 10. For example, the object processing module 160 may assign a virtual enter key or a virtual back space key as a virtual key button related to control of the input control object 10. If the virtual enter key is selected while the input control object 10 is output, the object processing module 160 may control function execution according to a location where the input control object 10 is positioned. If the virtual backspace key is selected while the input control object 10 is output, the object processing module 160 may remove the input control object 10. If a function is applied at a location where the input control object 10 is removed or positioned, the message input buttons 1650 may be used as buttons related to a message writing function. The object processing module 160 may provide an additional display effect to buttons related to control of the input control object 10 among the message input buttons 1650 so as to assist in recognizing that the buttons are used for operating the input control object 10. When the input control object 10 is removed, the object processing module 160 may equalize the display effect of the message input buttons 1650.

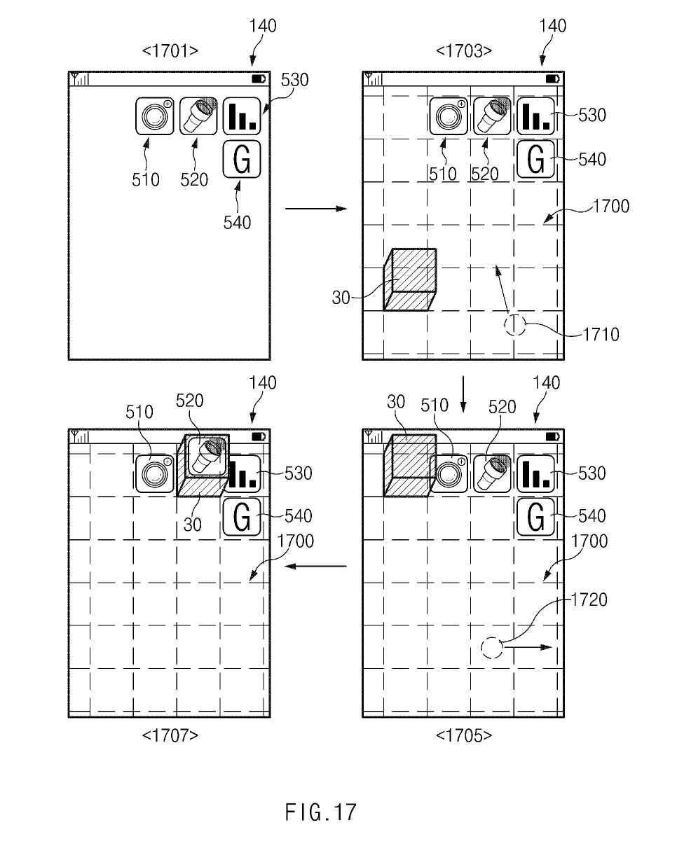

FIG. 17 is a diagram illustrating map movement of the input control object, according to an embodiment of the present disclosure.

Referring to FIG. 17, the display 140 outputs items 510, 520, 530, and 540 on a screen according to execution of a specific function or a standby screen, as illustrated in state 1701. The object processing module 160 may output the input control object 10 to the display 140 in response to an event related to the call of the input control object 10. According to an embodiment, the object processing module 160 outputs a certain map (e.g., a lattice map 1700) to the display 140, as illustrated in a screen 1703. The lattice map 1700 may be such disposed that the items 510 to 540 are divided. For example, the items 510, 520, 530, and 540 are each disposed in respective lattices of the lattice map 1700. Embodiments of the present disclosure are not limited to the lattice-type map. For example, the map may be a type that divides a screen area of the display 140 using a plurality of lines and planes. Alternatively, the map may include at least one guide line along which the input control object is moved.

According to an embodiment of the present disclosure, the object processing module 160 outputs an input control lattice object 30 to the lattice map 1700. When a first touch event 1710 occurs, the object processing module 160 moves the input control lattice object 30 on the lattice map 1700 in response to the first touch event 1710. The input control lattice object 30 may be moved in various directions, for example, horizontally, vertically or diagonally. The object processing module 160 may adjust an amount of movement of the input control lattice object 30 according to the first touch event 1710. For example, the object processing module 160 may adjust a movement distance or a moving speed of the input control lattice object 30 according to a flick speed or a drag distance of the first touch event 1710. When moving the input control lattice object 30, the object processing module 160 may control the input control lattice object 30 so that it is moved while changing a face of a three-dimensional body thereof. For example, the object processing module 160 may provide such a display effect that the input control lattice object 30 displayed three dimensionally appears to roll while the input control lattice object 30 is moved in such a manner that each face of the input control lattice object 30 corresponds to each lattice unit of the lattice map 1700.

According to an embodiment of the present disclosure, the object processing module 160 changes a moving direction of the input control lattice object 30 in response to a second touch event 1720, as illustrated in a screen 1705. The input control lattice object 30 may be stopped if the input control lattice object 30 is adjacent to an edge area of the display 140 while being moved in response to a touch event. Alternatively, as described above, the input control lattice object 30 may be bounced against an edge of the display 140 to continue to move in a reflection angle direction opposite to an incidence angle direction.

According to an embodiment of the present disclosure, when the input control lattice object 30 passes through the items 510, 520, 530, and 540 in response to the second touch event 1720, an item disposed on a lattice on which the input control lattice object 30 is positioned may be applied to a display effect of the input control lattice object 30, as illustrated in a state 1707. For example, the second item 520 is disposed on a certain location of the input control lattice object 30. If the input control lattice object 30 is moved out of a lattice on which the second item 520 is positioned, the second item 520 is disposed on the lattice again. According to an embodiment of the present disclosure, when the input control lattice object 30 is disposed on a location where the third item 530 is positioned, the third item 530 is disposed on at least one surface of the input control lattice object 30.

According to an embodiment of the present disclosure, the input control lattice object 30 may copy each item while moving on lattices on which the items are arranged. For example, if the input control lattice object 30 has passed through lattices on which the first to third items 510 to 530 are arranged, the first to third items 510 to 530 may be copied and arranged on a plurality of faces of the input control lattice object 30 (e.g., three faces of a rectangular parallelepiped). The object processing module 160 may control execution of a function related to a specific item if a predetermined event occurs while the specific item is disposed on a specific face among the plurality of faces of the input control lattice object 30 (e.g., an upper face of the input control lattice object 30, a face of the input control lattice object 30 on which an item is displayed to be seen at the front thereof, or a face of the input control lattice object 30 which opposes a screen). For example, if a predetermined event occurs while the second item 520 is disposed on an upper end part of the input control lattice object 30, the object processing module 160 may control execution of a function related to the second item 520. Alternatively, the object processing module 160 may remove the second item 520 from at least one of the display 140 or the input control lattice object 30 according to the type of an event.

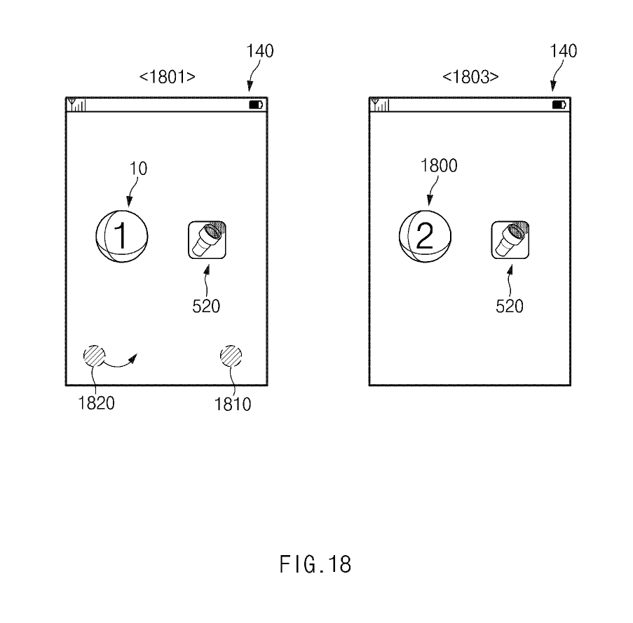

FIG. 18 is a diagram illustrating attribute control of the input control object, according to an embodiment of the present disclosure.

Referring to FIG. 18, the display 140 outputs the item 520 in a screen according to execution of a specific function or a standby screen, as illustrated in a state 1801. The object processing module 160 outputs the input control object 10 to the display 140 in response to an event related to the calling of the input control object 10.

At least one attribute may be designated for the input control object 10. For example, an attribute of execution, deletion, or movement of the input control object 10 may be designated. The input control object 10 may display information corresponding to a designated attribute. For example, the input control object 10 displays first attribute information, as illustrated in state 1801. The first attribute information may include, for example, execution, movement, a lifetime, or a moving speed. When the input control object 10 having the first attribute information overlaps the second item 520, a function related to the second item 520 may be executed. According to an embodiment of the present disclosure, when the input control object 10 overlaps items, the overlapped items may be arranged on at least one surface of the input control object 10. A currently overlapped item may be disposed on an upper surface of the input control object 10 so as to be identified by the user, as illustrated in the state 1707 of FIG. 17.

When a specified touch event, for example, a plurality of touch events 1810 and 1820, occurs, as illustrated in the state 1801, the object processing module 160 controls an attribute of the input control object 10, as illustrated in a state 1803. For example, if the touch-down event 1810 and the drag event 1820 occur while the input control object 10 is output, the object processing module 160 displays new second attribute information on a front surface while rotating the input control object 10. The input control object 10 may apply a function according to the second attribute information. The second attribute information may include, for example, deletion, movement, a lifetime, or a moving speed. When the input control object 10 defined by the second attribute information overlaps the second item 520, the object processing module 160 may perform an operation corresponding to the second attribute information.

According to various embodiments of the present disclosure, an electronic device according to an embodiment of the present disclosure may include a display for outputting at least one input control object and a virtual map allowing the input control object to move thereon, and an object processing module for moving the input control object in a certain direction or at a specific moving speed on the virtual map on the basis of an event or performing a specific function in response to the event.

According to various embodiments of the present disclosure, the object processing module may output the input control object to a designated location on the display.

According to various embodiments of the present disclosure, the object processing module may output the input control object to a certain location on the display related to an occurrence location of the event (related to output of the input control object).

According to various embodiments of the present disclosure, the object processing module may output at least one item to a certain area of the virtual map.

According to various embodiments of the present disclosure, the object processing module may allow selection of an item, at least a part of which is overlapped with the input control object, on the basis of the event.

According to various embodiments of the present disclosure, the object processing module may perform at least one of execution of a function related to the item, at least a part of which is overlapped with the input control object, removal of the item, or movement of the item.

According to various embodiments of the present disclosure, the object processing module may copy an image of the item, at least a part of which is overlapped with the input control object, to at least a part of the input control object on the basis of the event.

According to various embodiments of the present disclosure, when the image of the item copied to the input control object is selected, the object processing module may control execution of a function related to the item.

According to various embodiments of the present disclosure, the object processing module may output the input control object including a plurality of faces or may display another face of the input control object in response to movement thereof.

According to various embodiments of the present disclosure, the event may be a touch event occurring on a specific location of the display spaced apart from the input control object by a specific distance.

According to various embodiments of the present disclosure, an electronic device operating method according to an embodiment of the present disclosure may include outputting, to a display, at least one input control object and a virtual map allowing the input control object to move thereon, and moving the input control object in a certain direction or at a specific moving speed on the virtual map on the basis of an event or performing a specific function in response to the event.

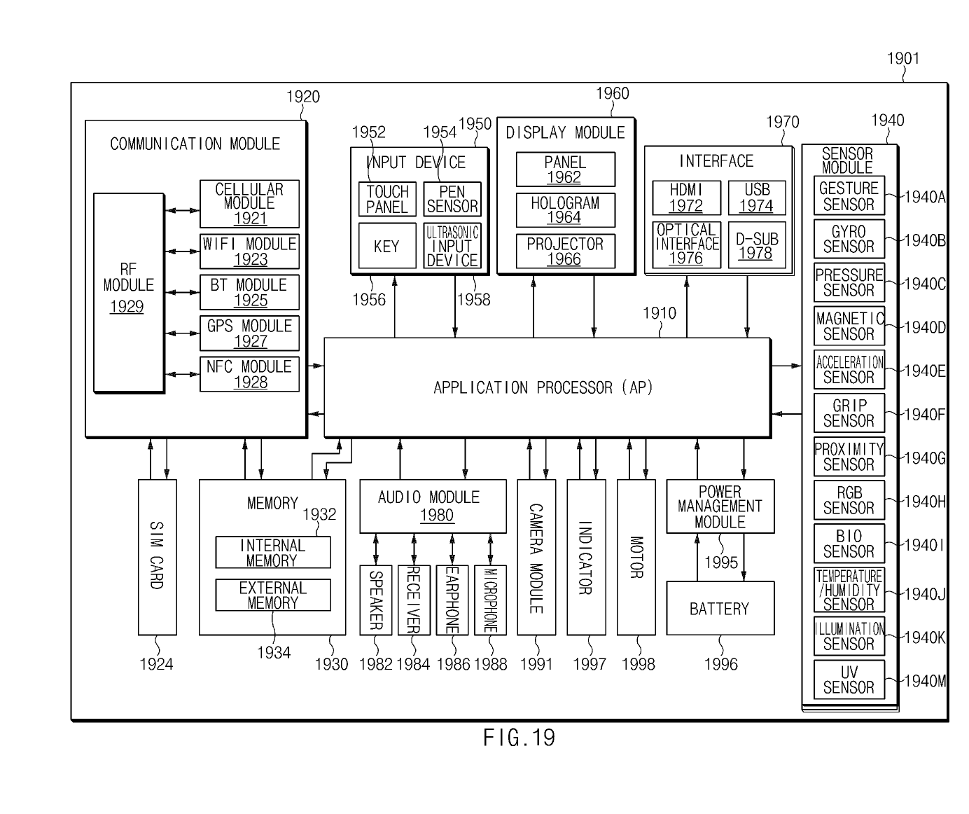

FIG. 19 is a block diagram illustrating an electronic device, according to an embodiment of the present disclosure.

An electronic device 1900 may constitute, for example, a part or the entirety of the electronic device 100 illustrated in FIG. 1. Referring to FIG. 19, the electronic device 1900 includes at least one application processor (AP) 1910 (e.g., the processor 120 or the object processing module 160), a communication module 1920 (e.g., the communication interface 110), a subscriber identification module (SIM) card 1924, a memory 1930 (e.g., the memory 150), a sensor module 1940, an input device 1950 (e.g., the input/output interface 130), a display module 1960 (e.g., the display 140), an interface 1970, an audio module 1980 (e.g., the input/output interface 130), a camera module 1991, a power management module 1995, a battery 1996, an indicator 1997, and a motor 1998.

The AP 1910 may run an operating system or an application program so as to control a plurality of hardware or software components connected to the AP 1910, may process various data including multimedia data, and may perform an operation. The AP 1910 may be implemented with, for example, a system on chip (SoC). According to an embodiment of the present disclosure, the AP 1910 may further include a graphic processing unit (GPU).

The communication module 1920 (e.g., the communication interface 110) may perform data transmission/reception for communication between the electronic device 1900 (e.g., the electronic device 100) and other electronic devices (e.g., the external electronic device 104 or the server device 106) connected thereto through a network. According to an embodiment of the present disclosure, the communication module 1920 may include a cellular module 1921, a WiFi module 1923, a BT module 1925, a GPS module 1927, an NFC module 1928, and a radio frequency (RF) module 1929.

The cellular module 1921 may provide a voice call service, a video call service, a text message service, or an Internet service through a telecommunications network (e.g., LTE, LTE-A, CDMA, WCDMA, UMTS, WiBro or GSM network). Furthermore, the cellular module 1921 may identify and authenticate electronic devices in the telecommunications network using, for example, the SIM card 1924. According to an embodiment of the present disclosure, the cellular module 1921 may perform at least a portion of functions provided by the AP 1910. For example, the cellular module 1921 may perform at least a portion of a multimedia control function.

According to an embodiment of the present disclosure, the cellular module 1921 may include a communication processor (CP). The cellular module 1921 may be implemented with, for example, an SoC. Although FIG. 19 illustrates that the cellular module 1921 (e.g., a communication processor), the memory 1930, and the power management module 1995 are separate from the AP 1910, the AP 1910 may include at least a portion of the foregoing elements (e.g., the cellular module 1921), according to an embodiment of the present disclosure.

According to an embodiment of the present disclosure, the AP 1910 or the cellular module 1921 (e.g., a communication processor) may load, on a volatile memory, a command or data received from at least one of a nonvolatile memory or other elements connected to the AP 1910 or the cellular module 1921, so as to process the command or data. Furthermore, the AP 1910 or the cellular module 1921 may store, in the nonvolatile memory, data received from or generated by at least one of the other elements.

Each of the WiFi module 1923, the BT module 1925, the GPS module 1927, and the NFC module 1928 may include, for example, a processor for processing data transmitted/received through the modules. FIG. 19 illustrates that the cellular module 1921, the WiFi module 1923, the BT module 1925, the GPS module 1927, and the NFC module 1928 are separate blocks. However, according to an embodiment of the present disclosure, at least a portion (e.g., two or more) of the cellular module 1921, the WiFi module 1923, the BT module 1925, the GPS module 1927, and the NFC module 1928 may be included in a single integrated chip (IC) or IC package. For example, at least a portion of processors corresponding to the cellular module 1921, the WiFi module 1923, the BT module 1925, the GPS module 1927, and the NFC module 1928 (e.g., a communication processor corresponding to the cellular module 1921 and a WiFi processor corresponding to the WiFi module 1923) may be implemented with a single SoC.

The RF module 1929 may transmit/receive data, for example, an RF signal. For example, a transceiver, a power amp module (PAM), a frequency filter, or a low noise amplifier (LNA) may be included in the RF module 1929. Furthermore, the RF module 1929 may further include a component such as a conductor or a wire for transmitting/receiving free-space electromagnetic waves in a wireless communication system. FIG. 19 illustrates that the cellular module 1921, the WiFi module 1923, the BT module 1925, the GPS module 1927, and the NFC module 1928 share the single RF module 1929. However, according to an embodiment of the present disclosure, at least one of the cellular module 1921, the WiFi module 1923, the BT module 1925, the GPS module 1927, and the NFC module 1928 may transmit/receive RF signals through an additional RF module.

The SIM card 1924 may be inserted into a slot formed at a specific location of the electronic device. The SIM card 1924 may include unique identification information (e.g., an integrated circuit card identifier (ICCID)) or subscriber information (e.g., international mobile subscriber identity (IMSI)).

The memory 1930 (e.g., the memory 150) includes an internal memory 1932 and/or an external memory 1934. The internal memory 1932 may include at least one of a volatile memory (e.g., a dynamic random access memory (RAM) (DRAM), a static RAM (SRAM), or a synchronous dynamic RAM (SDRAM)) or a nonvolatile memory (e.g., a one-time programmable read only memory (ROM) (OTPROM), a programmable ROM (PROM), an erasable and programmable ROM (EPROM), an electrically erasable and programmable ROM (EEPROM), a mask ROM, a flash ROM, a NAND flash memory, or a NOR flash memory). The above-described input control program 155 may be installed in at least one of the external memory or the internal memory.

According to an embodiment of the present disclosure, the internal memory 1932 may be a solid state drive (SSD). The external memory 1934 may include a flash drive, for example, compact flash (CF), secure digital (SD), micro secure digital (Micro-SD), mini secure digital (Mini-SD), extreme digital (xD), or a memory stick. The external memory 1934 may be functionally connected to the electronic device 1900 through various interfaces. According to an embodiment of the present disclosure, the electronic device 1900 may further include a storage device (or a storage medium) such as a hard drive.

The sensor module 1940 may measure physical quantity or detect an operation state of the electronic device 1900 so as to convert measured or detected information into an electrical signal. The sensor module 1940 includes, for example, at least one of a gesture sensor 1940A, a gyro sensor 1940B, a barometric pressure sensor 1940C, a magnetic sensor 1940D, an acceleration sensor 1940E, a grip sensor 1940F, a proximity sensor 1940G, a color sensor 1940H (e.g., a red/green/blue (RGB) sensor), a biometric sensor 12401, a temperature/humidity sensor 1940J, an illumination sensor 1940K, and an ultraviolet (UV) sensor 1940M. Additionally or alternatively, the sensor module 1940 may include, for example, an olfactory sensor (E-nose sensor), an electromyography (EMG) sensor, an electroencephalogram (EEG) sensor, an electrocardiogram (ECG) sensor, an infrared (IR) sensor, an iris recognition sensor, or a fingerprint sensor. The sensor module 1940 may further include a control circuit for controlling at least one sensor included therein.

The input device 1950 includes a touch panel 1952, a (digital) pen sensor 1954, a key 1956, and/or an ultrasonic input device 1958. The touch panel 1952 may recognize a touch input using at least one of capacitive, resistive, infrared, and ultraviolet sensing methods. The touch panel 1952 may further include a control circuit. When using the capacitive sensing method, a physical contact recognition or proximity recognition is allowed. The touch panel 1952 may further include a tactile layer that enables the touch panel 1952 to provide a tactile reaction to a user.

The (digital) pen sensor 1954 may be implemented in a similar or same manner as that for receiving a touch input of a user, or may be implemented using an additional sheet for recognition. The key 1956 may include, for example, a physical button, an optical button, or a keypad. The ultrasonic input device 1958 may enable the electronic device 1900 to sense, through a microphone (e.g., a microphone 1988), sound waves from an input tool that generates ultrasonic signals so as to identify data. The ultrasonic input device 1958 is capable of wireless recognition. According to an embodiment of the present disclosure, the electronic device 1900 may use the communication module 1920 so as to receive a user input from an external device (e.g., a computer or server) connected to the communication module 1920.

The display module 1960 (e.g., the display 150) includes a panel 1962, a hologram device 1964, and/or a projector 1966. The panel 1962 may be, for example, a liquid crystal display (LCD) or an active-matrix organic light-emitting diode (AM-OLED). The panel 1962 may be, for example, flexible, transparent, or wearable. The panel 1962 and the touch panel 1952 may be integrated into a single module. The hologram device 1964 may display a stereoscopic image in a space using a light interference phenomenon. The projector 1966 may project light onto a screen so as to display an image. The screen may be disposed in the inside or the outside of the electronic device 1900. According to an embodiment of the present disclosure, the display 1960 may further include a control circuit for controlling the panel 1962, the hologram device 1964, or the projector 1966.

The interface 1970 includes, for example, a high definition multimedia interface (HDMI) 1972, a universal serial bus (USB) 1974, an optical interface 1976, and/or a D-subminiature (D-sub) 1978. The interface 1970 may be included in the input/output interface 130 or the communication module 110 illustrated in FIG. 1. Additionally or alternatively, the interface 1970 may include, for example, a mobile high-definition link (MHL) interface, a secure digital (SD) card/multi-media card (MMC) interface, or an infrared data association (IrDA) interface.

The audio module 1980 may convert a sound into an electrical signal or vice versa. At least a portion of elements of the audio module 1980 may be included in the input/output interface 130 illustrated in FIG. 1. The audio module 1980 may process sound information input or output through a speaker 1982, a receiver 1984, an earphone 1986, or the microphone 1988.

According to an embodiment of the present disclosure, the camera module 1991 for shooting a still image or a video may include at least one image sensor (e.g., a front sensor or a rear sensor), a lens, an image signal processor (ISP), or a flash (e.g., an LED or a xenon lamp).

The power management module 1995 may manage power of the electronic device 1900. A power management integrated circuit (PMIC), a charger integrated circuit (IC), or a battery gauge may be included in the power management module 1995.

The PMIC may be mounted on an integrated circuit or an SoC semiconductor. A charging method may be classified as a wired charging method or a wireless charging method. The charger IC may charge a battery, and may prevent an overvoltage or an overcurrent from being introduced from a charger. According to an embodiment of the present disclosure, the charger IC may include a charger IC for at least one of the wired charging method and the wireless charging method. The wireless charging method may include, for example, a magnetic resonance method, a magnetic induction method, or an electromagnetic method, and may include an additional circuit, for example, a coil loop, a resonant circuit, or a rectifier.

The battery gauge may measure, for example, a remaining capacity of the battery 1996 and a voltage, current, or temperature thereof while the battery is charged. The battery 1996 may store or generate electricity, and may supply power to the electronic device 1900 using the stored or generated electricity. The battery 1996 may include, for example, a rechargeable battery or a solar battery.

The indicator 1997 may indicate a specific state of the electronic device 1900 or a part thereof (e.g., the AP 1910), such as a booting sate, a message sate, or a charging state. The motor 1998 may convert an electrical signal into a mechanical vibration. A processing device (e.g., a GPU) for supporting a mobile TV may be included in the electronic device 1900. The processing device for supporting a mobile TV may process media data according to the standards of digital multimedia broadcasting (DMB), digital video broadcasting (DVB) or media flow.

Each of the above-described elements of the electronic device, according to various embodiments of the present disclosure, may be configured with one or more components, and the names of the elements may be changed according to the type of the electronic device. The electronic device, according to various embodiments of the present disclosure, may include at least one of the above-mentioned elements, and some elements may be omitted or other additional elements may be added. Furthermore, some of the elements of the electronic device, according to various embodiments of the present disclosure, may be combined with each other so as to form one entity, so that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” or “circuit”. A module may be a minimum unit of an integrated component or may be a part thereof. A module may be a minimum unit for performing one or more functions or a part thereof. A module may be implemented mechanically or electronically. For example, a module, according to various embodiments of the present disclosure, may include at least one of an application-specific integrated circuit (ASIC) chip, a field-programmable gate array (FPGA), or a programmable-logic device for performing some operations, which are known or will be developed.

According to various embodiments of the present disclosure, at least a part of the devices (e.g., modules or functions thereof) or methods (e.g., operations) may be implemented as instructions stored in a computer-readable storage medium in the form of a programming module. When the instructions are performed by at least one processor (e.g., the processor 120), the at least one processor may perform functions corresponding to the instructions. The computer-readable storage medium may be, for example, the memory 150. At least a part of the programming module may be implemented (e.g., executed) by the processor 120. At least a part of the programming module may include, for example, a module, a program, a routine, sets of instructions, or a process for performing at least one function.

The computer-readable storage medium may include a magnetic medium such as, for example, a hard disk, a floppy disk, and a magnetic tape, an optical medium such as, for example, a compact disk read only memory (CD-ROM) and a digital versatile disc (DVD), a magneto-optical medium such as, for example, a floptical disk, and a hardware device configured to store and execute program instructions (e.g., programming module), such as, for example, a ROM, a RAM, and a flash memory. The program instructions may include machine language codes made by compilers and high-level language codes that can be executed by computers using interpreters. The above-described hardware may be configured to be operated as one or more software modules for performing operations of various embodiments of the present disclosure and vice versa.

The module or programming module, according to various embodiments of the present disclosure, may include at least one of the above-mentioned elements, or some elements may be omitted or other additional elements may be added. Operations performed by the module, the programming module, or the other elements may be performed in a sequential, parallel, iterative, or heuristic way. Furthermore, some operations may be performed in another order or may be omitted, or other operations may be added.

According to an embodiment of the present disclosure, a storage medium or a computer-readable medium stores commands executed by at least one processor to instruct the at least one processor to perform at least one operation. The at least one operation may include outputting at least one virtual input control object that is controlled to be able to be moved to a certain location on a screen of a display, or requesting processing of a designated function at a specific location in response to an event.

According to various embodiments of the present disclosure, a storage medium or a computer-readable medium stores commands executed by at least one processor to instruct the at least one processor to perform at least one operation, wherein the at least one operation may include outputting an input control object to a display in response to an event that occurs in an electronic device, moving the input control object on the display in a certain direction or at a certain speed on the basis of a first event, and performing a function corresponding to a request of the input control object on the basis of a second event.

According to various embodiments of the present disclosure, a storage medium or a computer-readable medium stores commands executed by at least one processor to instruct the at least one processor to perform at least one operation, wherein the at least one operation may include outputting, to a display, at least one input control object and a virtual map allowing the input control object to move thereon, and moving the input control object in a certain direction or at a specific moving speed on the virtual map on the basis of an event or performing a specific function in response to the event.

According to the input control object operating method and the electronic device supporting the same proposed in various embodiments of the present disclosure, items output to a display module can be selected more easily.

Furthermore, an input control operation related to a screen change of the display module can be performed more easily.

Moreover, input interfacing for arousing user's interest can be supported, according to various embodiments of the present disclosure.

While the disclosure has been shown and described with reference to certain embodiments thereof, it will be understood by those skilled in the art that various changes in form and detail may be made therein without departing from the spirit and scope of the disclosure as defined by the appended claims.

What is claimed is:

1. A method for operating an input control object, the method comprising:
outputting at least one virtual input control object to a display in response to a first event;
moving the at least one virtual input control object on the display in a designated direction or at a designated speed according to a second event; and
performing a function related to the at least one virtual input control object according to a third event.

2. The method according to claim 1, wherein the first event comprises at least one of occurrence of a specified touch event, occurrence of a plurality of specified touch events, occurrence of a specified sensor event, occurrence of a specified virtual button selection event, occurrence of a specified hardware button selection event, occurrence of a specified touch event on a certain area of the display, or occurrence of a specific function execution event.

3. The method according to claim 1, wherein performing the function comprises outputting a specific function execution screen to the display according to a motion of the virtual input control object.

4. The method according to claim 1, wherein performing the function comprises at least one of:
removing at least one item selected according to movement of the at least one virtual input control object;
executing the function supported by the at least one item selected according to the movement of the at least one virtual input control object; and
moving a location of the at least one item selected according to the movement of the virtual input control object.

5. The method according to claim 4, wherein moving the location of the at least one item comprises moving the at least one virtual input control object in response to a touch event that occurs on an uppermost layer.

6. The method according to claim 4, wherein moving the location of the at least one item comprises changing at least one of a moving speed, a size, a location, a shape, or a lifetime of the at least one virtual input control object based on the location of the at least one virtual input control object relative to a location of the at least one item on the display.

7. The method according to claim 6, wherein changing at least one of the moving speed, the size, the location, the shape, and the lifetime of the at least one virtual input control object comprises changing at least one of the moving speed or the size of the at least one virtual input control object based on a distance between the at least one virtual input control object and the at least one item on the display, or based on whether the at least one virtual input control object and the at least one item overlap each other on the display.

8. The method according to claim 6, wherein changing at least one of the moving speed, the size, the location, the shape, and the lifetime of the at least one virtual input control object comprises moving the at least one virtual input control object so that the at least one virtual input control object is adjacent to the at least one item on the display if the at least one virtual input control object approaches within a specific distance from the at least one item.

9. The method according to claim 1, further comprising at least one of:
assigning an input area for generating a touch event related to movement control of the at least one virtual input control object; and
outputting a map related to movement of the at least one virtual input control object.

10. The method according to claim 1, further comprising adjusting at least one of a function application attribute, a movement-related attribute, or a lifetime of the at least one virtual input control object according to a fourth event.

11. An electronic device comprising:
a display configured to output at least one virtual input control object in response to a first event; and
an object processing module configured to move the at least one virtual input control object in a designated direction or at a designated speed according to a second event, and perform a function related to the at least one virtual input control object according to a third event.

12. The electronic device according to claim 11, wherein the object processing module is further configured to output the at least one virtual input control object in response to at least one of occurrence of a specified touch event, occurrence of a plurality of specified touch events, occurrence of a specified sensor event, occurrence of a specified virtual button selection event, occurrence of a specified hardware button selection event, occurrence of a specified touch event on a certain area of the display, or occurrence of a specific function execution event.

13. The electronic device according to claim 11, wherein the object processing module is further configured to output a specific function execution screen to the display according to a designated operation of the virtual input control object.

14. The electronic device according to claim 13, wherein the object processing module controls at least one of removal of a selected item, execution of a function supported by the selected item, or location movement of the selected item according to movement of the virtual input control object.

15. The electronic device according to claim 14, wherein the object processing module is further configured to move the at least one virtual input control object in response to a touch event that occurs on an uppermost layer.

16. The electronic device according to claim 14, wherein the object processing module is further configured to change at least one of a moving speed, a size, a location, a shape, or a lifetime of the at least one virtual input control object based on the location of the at least one virtual input control object relative to a location of the at least one item on the display.

17. The electronic device according to claim 16, wherein the object processing module is further configured to change at least one of the moving speed or the size of the at least one virtual input control object based on a distance between the at least one virtual input control object and the at least one item on the display, or based on whether the at least one virtual input control object and the at least one item overlap each other on the display.

18. The electronic device according to claim 16, wherein the object processing module is further configured to move the at least one virtual input control object so that the at least one virtual input control object is adjacent to the at least one item on the display if the at least one virtual input control object approaches within a specific distance from the at least one item.

19. The electronic device according to claim 11, wherein the object processing module is further configured to, at least one of, assign an input area for generating a touch event related to movement control of the at least one virtual input control object, or output of a map related to movement of the at least one virtual input control object.

20. The electronic device according to claim 11, wherein the object processing module is further configured to adjust at least one of a function application attribute, a movement-related attribute, or a lifetime of the virtual input control object according to a fourth event.
